(19) United States
(12) Patent Application Publication
(10) Pub. No.: US 2010/0149462 A1
(43) Pub. Date: Jun. 17, 2010

(54) DISPLAY APPARATUS

(75) Inventors: Toshiharu NISHINO, Hamura-shi (JP); Norihiro Arai, Hino-shi (JP); Kazuhiro Sasaki, Sagamihara-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Casio Computer Co., Ltd., Tokyo (JP)

(21) Appl. No.: 12/625,992

(22) Filed: Nov. 25, 2009

(30) Foreign Application Priority Data
Dec. 11, 2008 (JP) 2008-315967

(51) Int. Cl. G02F 1/1335; G02B 5/30

(52) U.S. Cl. 349/102; 359/494

(57) ABSTRACT

A display apparatus includes a liquid crystal element that has a liquid crystal layer sealed in a space between a first substrate and a second substrate arranged face to face, a protective plate that is disposed so that the first substrate intervenes between the protective plate and the second substrate, a first polarizing plate that is disposed between the protective plate and the first substrate to be in close contact with the protective plate, and a first quarter-wavelength retardation plate that is disposed between the first substrate and the first polarizing plate to be in close contact with the first polarizing plate. The protective plate is greater in area than the first substrate. The first polarizing plate has an absorption axis and the first quarter-wavelength retardation plate has a slow axis in a direction intersecting with the absorption axis of the first polarizing plate at an angle of 45°.

### CROSS-REFERENCE TO RELATED APPLICATIONS

This application is based upon and claims the benefit of priority from prior Japanese Patent Application No. 2008-315967, filed Dec. 11, 2008, the entire contents of which are incorporated herein by reference.

### BACKGROUND OF THE INVENTION

1. Field of the Invention

This invention relates to a display apparatus provided with a protective plate.

2. Description of the Related Art

There is a display apparatus that configures a display unit of electronic equipment such as a mobile telephone, a digital camera or an electronic dictionary, wherein a transparent protective plate is disposed on the observation side (the side where an observer observes images displayed on the display apparatus) of a display device such as a liquid crystal display device.

In this display apparatus, part of a light that enters the display apparatus from the observation side (a light in the environment where the display apparatus is used) is reflected by the observation-side surface of the protective plate and by the surface of the protective plate that faces the display device. Moreover, part of the light that has penetrated the protective plate is reflected by the observation-side surface of the display device. Then, the resulting reflected lights reduce the contrast of display.

Thus, it has heretofore been the case that a film coated for the prevention of reflection is provided on the surface of the protective plate that faces the display device, thereby reducing the reflection of the light on the surface of the protective plate that faces the display device (Jpn. Pat. Appln. KOKAI Publication No. 11-38402).

However, the light entering the display apparatus from the observation side is still reflected by the observation-side surface of the protective plate, by the surface of the protective plate that faces the display device and by the observation-side surface of the display device. Thus, the conventional display apparatus does not sufficiently prevent the surface reflection.

### BRIEF SUMMARY OF THE INVENTION

It is therefore an object of this invention to provide a display apparatus that is provided with a protective plate and that is, nevertheless, capable of sufficiently preventing surface reflection and performing display with high contrast.

A display apparatus according to an aspect of this invention includes: a liquid crystal element having a liquid crystal layer sealed in a space between a first substrate and a second substrate that are arranged face to face with each other, liquid crystal molecules being aligned in a predetermined alignment state in the liquid crystal layer, the liquid crystal element being provided with a plurality of pixels that change the alignment state of the liquid crystal molecules in response to the application of a voltage to the liquid crystal layer to control the transmission of a light; a protective plate that is greater in area than the first substrate and that is disposed so that the first substrate intervenes between the protective plate and the second substrate; a first polarizing plate that has an absorption axis in a predetermined direction and that is disposed between the protective plate and the first substrate to be in close contact with the protective plate; and a first quarter-wavelength retardation plate that has a slow axis in a direction intersecting with the absorption axis of the first polarizing plate at an angle of 45° and that is disposed between the first substrate and the first polarizing plate to be in close contact with the first polarizing plate.

A display apparatus according to another aspect of this invention includes: a liquid crystal element having a liquid crystal layer sealed in a space between a first substrate and a second substrate that are arranged face to face with each other, liquid crystal molecules being aligned in a predetermined alignment state in the liquid crystal layer, the liquid crystal element being provided with a plurality of pixels that change the alignment state of the liquid crystal molecules in response to the application of a voltage to the liquid crystal layer to control the transmission of a light; a protective plate that is greater in area than the first substrate and that is disposed so that the first substrate intervenes between the protective plate and the second substrate; a first polarizing plate that has an absorption axis in a predetermined direction and that is disposed between the protective plate and the first substrate to be in close contact with the protective plate; a first quarter-wavelength retardation plate that has a slow axis in a direction intersecting with the absorption axis of the first polarizing plate at an angle of 45° and that is disposed between the first substrate and the first polarizing plate to be in close contact with the first substrate; and a second quarter-wavelength retardation plate that has a slow axis in a direction perpendicular to the slow axis of the first quarter-wavelength retardation plate and that is disposed between the first polarizing plate and the first quarter-wavelength retardation plate to be in close contact with the first polarizing plate.

A display apparatus according to another aspect of this invention includes: a liquid crystal element having a liquid crystal layer sealed in a space between a first substrate and a second substrate that are arranged face to face with each other, liquid crystal molecules being aligned in a predetermined alignment state in the liquid crystal layer, the liquid crystal element being provided with a plurality of pixels that change the alignment state of the liquid crystal molecules in response to the application of a voltage to the liquid crystal layer to control the transmission of a light; a protective plate that is greater in area than the first substrate and that is disposed so that the first substrate intervenes between the protective plate and the second substrate; a first polarizing plate that has an absorption axis in a predetermined direction and that is disposed between the protective plate and the first substrate to be in close contact with the protective plate; a first quarter-wavelength retardation plate that has a slow axis in a direction intersecting with the absorption axis of the first polarizing plate at an angle of 45° and that is disposed between the first substrate and the first polarizing plate to be in close contact with the first substrate; a second quarter-wavelength retardation plate that has a slow axis in a direction perpendicular to the slow axis of the first quarter-wavelength retardation plate and that is disposed between the first polarizing plate and the first quarter-wavelength retardation plate to be in close contact with the first polarizing plate; a second polarizing plate that has an absorption axis in a direction parallel to the absorption axis of the first polarizing plate and that is disposed between the first quarter-wavelength retardation plate and the second quarter-wavelength retardation plate to be in close contact with the first quarter-wavelength retardation plate; and a third quarter-wavelength retardation plate that has a slow axis in a direction intersecting with the absorption axis of the second polarizing plate at an angle of 45° and that is disposed between the second polarizing plate and the second quarter-wavelength retardation plate to be in close contact with the second polarizing plate.

A display apparatus according to another aspect of this invention includes: a liquid crystal element having a liquid crystal layer sealed in a space between a first substrate and a second substrate that are arranged face to face with each other, liquid crystal molecules being aligned in a predetermined alignment state in the liquid crystal layer, the liquid crystal element being provided with a plurality of pixels that change the alignment state of the liquid crystal molecules in response to the application of a voltage to the liquid crystal layer to control the transmission of a light; a protective plate that is greater in area than the first substrate and that is disposed so that the first substrate intervenes between the protective plate and the second substrate; a first polarizing plate that has an absorption axis in a predetermined direction and that is disposed between the protective plate and the first substrate to be in close contact with the protective plate; a second polarizing plate that has an absorption axis in a direction parallel to the absorption axis of the first polarizing plate and that is disposed between the first substrate and the first polarizing plate to be in close contact with the first substrate; a first quarter-wavelength retardation plate that has a slow axis in a direction intersecting with the absorption axis of the first polarizing plate at an angle of 45° and that is disposed between the first polarizing plate and the second polarizing plate to be in close contact with the first polarizing plate; and a second quarter-wavelength retardation plate that has a slow axis in a direction perpendicular to the slow axis of the first quarter-wavelength retardation plate and that is disposed between the first quarter-wavelength retardation plate and the second polarizing plate to be in close contact with the second polarizing plate.

A display apparatus according to another aspect of this invention includes: a light-emitting type display device; a protective plate; a polarizing plate that has an absorption axis in a predetermined direction and that is disposed between the light-emitting type display device and the protective plate to be in close contact with the protective plate; and a quarter-wavelength retardation plate that has a slow axis in a direction intersecting with the absorption axis of the polarizing plate at an angle of 45° and that is disposed between the light-emitting type display device and the polarizing plate to be in close contact with the polarizing plate.

The display apparatus of this invention is provided with the protective plate and is, nevertheless, capable of sufficiently preventing surface reflection and performing display with high contrast.

Advantages of the invention will be set forth in the description that follows, and in part will be obvious from the description, or may be learned by practice of the invention. The advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a side view of a display apparatus showing a first embodiment of the invention;

FIG. 2 is a partially enlarged sectional view of the display apparatus in the first embodiment;

FIG. 3 is a schematic plan view of the display apparatus in the first embodiment;

FIG. 4 shows the alignment state of a liquid crystal molecule of a liquid crystal element, the directions of absorption axes of observation side and rear side polarizing plates, and the directions of slow axes of first and second λ/4 plates, in the display apparatus according to the first embodiment;

FIG. 5 is a view of a light that enters the display apparatus from the observation side in the first embodiment;

FIG. 6 is a partially enlarged sectional view of a display apparatus showing a second embodiment of the invention;

FIG. 7 shows the alignment state of a liquid crystal molecule of a liquid crystal element, the directions of absorption axes of observation side and rear side polarizing plates, and the directions of slow axes of first and second λ/4 plates, in the display apparatus according to the second embodiment;

FIG. 8 is a partially enlarged sectional view of a display apparatus showing a third embodiment of the invention;

FIG. 9 is a schematic plan view of the display apparatus in the third embodiment;

FIG. 10 shows the alignment state of liquid crystal molecules of a liquid crystal element, the directions of absorption axes of observation side and rear side polarizing plates, and the directions of slow axes of first and second λ/4 plates, in the display apparatus according to the third embodiment;

FIG. 11 is a partially enlarged sectional view of a display apparatus showing a fourth embodiment of the invention;

FIG. 12 shows the alignment state of liquid crystal molecules of a liquid crystal element, the directions of absorption axes of observation side and rear side polarizing plates, and the directions of slow axes of first and second λ/4 plates, in the display apparatus according to the fourth embodiment;

FIG. 13 is a partially enlarged sectional view of a display apparatus showing a fifth embodiment of the invention;

FIG. 14 is a schematic plan view of the display apparatus in the fifth embodiment;

FIG. 15 shows the alignment state of a liquid crystal molecule of a liquid crystal element, the directions of absorption axes of first and second observation side polarizing plates and a rear side polarizing plate, and the directions of slow axes of first, second, third and fourth λ/4 plates, in the display apparatus according to the fifth embodiment;

FIG. 16 is a partially enlarged sectional view of a display apparatus showing a sixth embodiment of the invention;

FIG. 17 is a schematic plan view of the display apparatus in the sixth embodiment;

FIG. 18 shows the alignment state of a liquid crystal molecules of a liquid crystal element forming the liquid crystal display device, the directions of absorption axes of a pair of polarizing plates, the directions of slow axes of first and second λ/4 plates, and the direction of an absorption axis of a second observation side polarizing plate, in the display apparatus according to the sixth embodiment;

FIG. 19 is a partially enlarged sectional view of a display apparatus showing a seventh embodiment of the invention; and

FIG. 20 shows the direction of an absorption axis of a polarizing plate and the direction of a slow axis of a λ/4 plate, in the display apparatus according to the seventh embodiment.

### DETAILED DESCRIPTION OF THE INVENTION

### First Embodiment

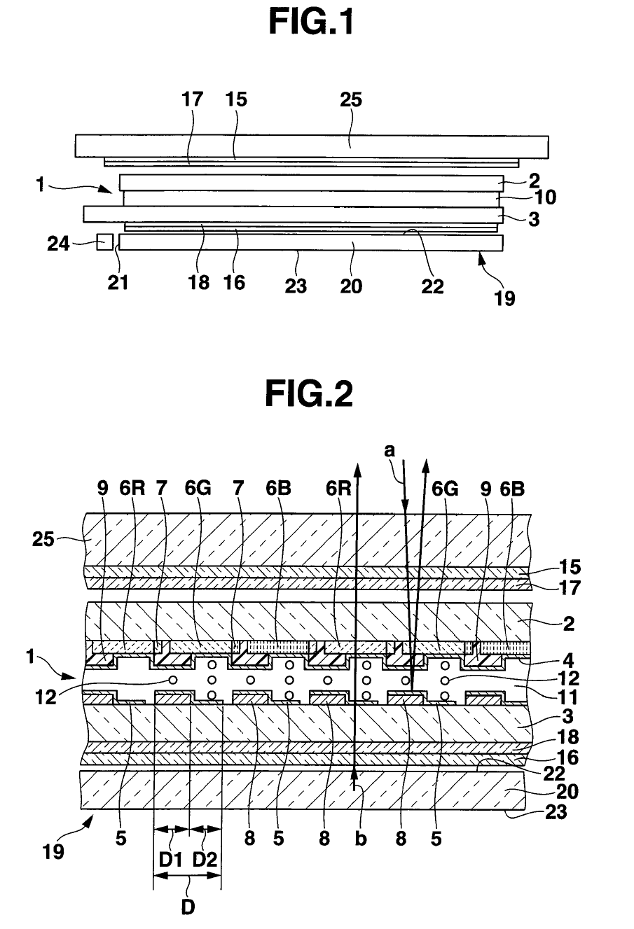

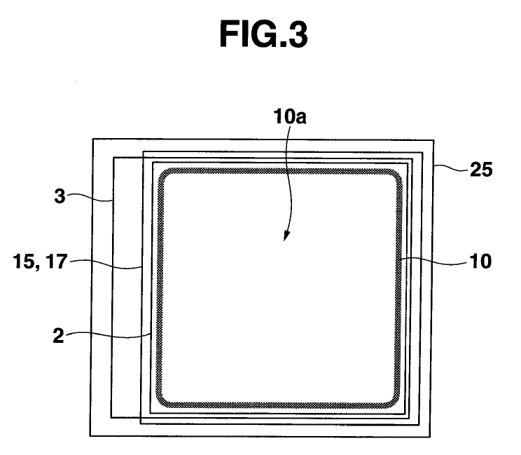

FIG. 1 to FIG. 4 show a first embodiment of the invention. FIG. 1 is a side view of a display apparatus. FIG. 2 is a partially enlarged sectional view of the display apparatus. FIG. 3 is a schematic plan view of the display apparatus.

As shown in FIG. 1, FIG. 2 and FIG. 3, this display apparatus comprises: a liquid crystal element 1; an observation side polarizing plate 15 disposed on the observation side (the side where an observer observes images displayed on the display apparatus) of the liquid crystal element 1; a rear side polarizing plate 16 disposed on the side of the liquid crystal element 1 opposite to the observation side; a first quarter-wavelength retardation plate 17 disposed between the liquid crystal element 1 and the observation side polarizing plate 15; a second quarter-wavelength retardation plate 18 disposed between the liquid crystal element 1 and the rear side polarizing plate 16; a surface light source 19 that is disposed on the rear side (opposite to the observation side) of the rear side polarizing plate 16 and that radiates an illumination light toward the liquid crystal element 1; and a transparent protective plate 25 that is made of, for example, hardened glass and that is disposed closer to the observation side than the observation side polarizing plate 15.

In the liquid crystal element 1, a liquid crystal layer 11 in which liquid crystal molecules 12 are aligned in a predetermined alignment state is sealed in a space between a pair of observation side and opposite transparent substrates 2, 3 that are arranged face to face to leave a predetermined space. Transparent electrodes 4, 5 are provided on at least one of the inner surfaces of the pair of substrates 2, 3 that face each other. The transparent electrodes 4, 5 form a plurality of pixels D that change the alignment state of the liquid crystal molecules in response to the application of a voltage to control the transmission of a light. The pair of substrates 2, 3 are joined together via a frame-shaped seal material 10. The liquid crystal layer 11 is sealed in the space enclosed by the seal material 10 between the pair of substrates 2, 3. In addition, the transparent substrate 3 is greater in area than the transparent substrate 2. Moreover, the protective plate 25 is greater in area than the transparent substrate 2.

In this embodiment, the liquid crystal element 1 is a nontwist homogeneous alignment type element: The electrodes 4, 5 are provided on the respective inner surfaces of the pair of substrates 2, 3 to form a plurality of pixels D by regions that face each other. The liquid crystal layer 11 made of nematic liquid crystal having positive dielectric anisotropy is sealed in the space between the pair of substrates 2, 3. The liquid crystal molecules 12 of the liquid crystal layer 11 are in homogeneous alignment substantially in parallel to the surfaces of the substrates 2, 3 so that the major axes of these molecules are aligned in a predetermined direction, and the liquid crystal molecules 12 are aligned to stand up on the surfaces of the substrates 2, 3 by the application of a voltage across the electrodes 4, 5.

In addition, the liquid crystal element 1 is an active matrix liquid crystal using a thin film transistor (TFT) as an active element. The electrode 4 provided on the inner surface of the observation side substrate 2 is an opposed electrode in the form of a single film. The electrodes 5 provided on the inner surface of the substrate (hereinafter referred to as a rear side substrate) 3 on the side opposite to the observation side are a plurality of pixel electrodes that are formed to be arranged in a row direction and a column direction.

Although not shown in FIG. 2, a plurality of TFTs, a plurality of scanning lines and a plurality of signal lines are provided on the inner surface of the rear side substrate 3. The plurality of TFTs are connected to the plurality of electrodes 5, respectively. The plurality of scanning lines supply gate signals to the TFTs in the respective rows. The plurality of signal lines supply data signals to the TFTs in the respective columns. Further, red, green and blue three color filters 6R, 6G, 6B are provided on the inner surface of the observation side substrate 2 to correspond to the plurality of pixels D.

Furthermore, this liquid crystal element 1 is a reflection/transmission type element in which a reflection portion D1 and a transmission potion D2 are formed. A reflection film 8 corresponding to a predetermined region in each of the plurality of pixels D, for example, half the region of the pixel D is provided on the inner surface of the rear side substrate 3. In each of the plurality of pixels D, the reflection portion D1 is formed by the region where the reflection film 8 is provided, and the reflection portion D1 causes the light that has entered from the observation side to be reflected by the reflection film 8 and then exit to the observation side. The transmission potion D2 is formed by the region of each of the plurality of pixels D excluding the reflection portion D1, and the transmission potion D2 transmits the light that has entered from the side opposite to the observation side, that is, the light radiated from the surface light source 19 and causes the light to exit to the observation side. The pixel electrode 5 is formed so that its part corresponding to the reflection portion D1 is laid on the reflection film 8.

On the inner surface of the observation side substrate 2, liquid crystal layer thickness adjusting films 9 are provided on the color filters 6R, 6G, 6B to correspond to the reflection portions D1 of the plurality of pixels D. The thickness of the liquid crystal layer of the reflection portion D1 is set at substantially half the thickness of the liquid crystal layer of the transmission potion D2 by the liquid crystal layer thickness adjusting film 9. In addition, the opposed electrode 4 is formed on the color filters 6R, 6G, 6B and the liquid crystal layer thickness adjusting film 9.

Although not shown in FIG. 2, the inner surfaces of the pair of substrates 2, 3 form homogeneous alignment films (not shown) to cover the electrodes 4, 5, and the surfaces of these alignment films are subjected to an aligning treatment by being rubbed in parallel to each other and in opposite directions. The liquid crystal molecules 12 of the liquid crystal layer 11 are in homogeneous alignment in a condition pretilted at an angle of about 1° to 5° to the surfaces of the substrates 2, 3 so that their major axes are aligned with the direction of the aligning treatment of the pair of substrates 2, 3. That is, when no voltage is applied to the liquid crystal layer 11, the liquid crystal molecules 12 of the liquid crystal layer 11 are in homogeneous alignment.

The product Δnd of the anisotropic refractive index Δn of the liquid crystal in the reflection portion D1 and the liquid crystal layer thickness d is set at a value that provides a quarter-wavelength phase difference (a half-wavelength phase difference after both-way passages) to the light that penetrates the liquid crystal layer 11 in one direction. Δnd of the transmission potion D2 is set at a value that provides a half-wavelength phase difference to the light that penetrates the liquid crystal layer 11 in one direction.

Furthermore, the color filters 6R, 6G, 6B are formed to have openings 7 provided in parts of the portions corresponding to the reflection portions D1. Thus, colored lights from which lights of the wavelength bands of the colors of the color filters 6R, 6G, 6B have been absorbed, and high-luminance uncolored lights that are not absorbed by the color filters 6R, 6G, 6B exit from the reflection portions D1 of the plurality of pixels D, thereby making reflection display brighter.

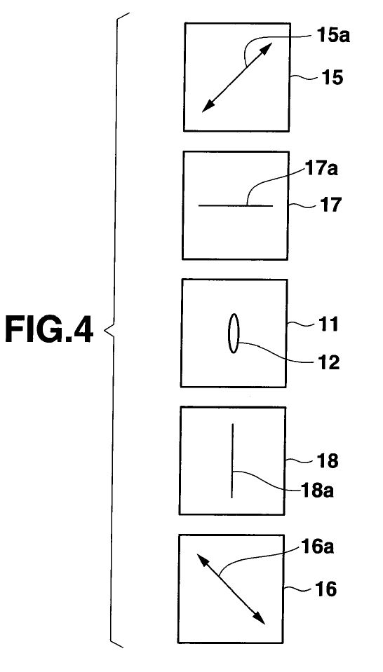

The observation side polarizing plate 15 and the rear side polarizing plate 16 are absorption polarizing plates for transmitting one of two linearly polarized lights having light vibration planes in directions perpendicular to each other and for absorbing the other linearly polarized light, respectively. The observation side polarizing plate 15 has an absorption axis 15a (see FIG. 4) in a direction predetermined in accordance with the alignment state of the liquid crystal molecules 12 of the liquid crystal element 1, and the rear side polarizing plate 16 has an absorption axis 16a (see FIG. 4) in a direction substantially perpendicular or parallel to the absorption axis 15a of the observation side polarizing plate 15. In addition, each of the observation side polarizing plate 15 and the rear side polarizing plate 16 has an area greater than that of a region 10a enclosed by the seal material 10, that is, has an area greater than that of a display area for displaying images.

The first and second quarter-wavelength retardation plates 17, 18 are retardation plates (hereinafter referred to as λ/4 plates) that provide a quarter-wavelength phase difference between an ordinary light and an extraordinary light of a transmitted light. The first λ/4 plate 17 has a slow axis 17a (see FIG. 4) in a direction intersecting with the absorption axis 15a of the observation side polarizing plate 15 at an angle of substantially 45°. The second λ/4 plate 18 has a slow axis 18a (see FIG. 4) in a direction substantially perpendicular to the slow axis 17a of the first λ/4 plate 17. In addition, each of the first and second λ/4 plates 17, 18 has an area greater than that of the region 10a enclosed by the seal material 10.

FIG. 4 shows the alignment state of the liquid crystal molecule 12 of the liquid crystal element 1, the directions of the absorption axes 15a, 16a of the observation side and rear side polarizing plates 15, 16, and the directions of the slow axes 17a, 18a of the first and second λ/4 plates 17, 18.

As shown in FIG. 4, the liquid crystal molecules 12 of the liquid crystal layer 11 of the liquid crystal element 1 are in homogeneous alignment so that their major axes are aligned in a predetermined direction, for example, the vertical direction of the screen of the display apparatus. The observation side polarizing plate 15 is disposed so that its absorption axis 15a intersects with the homogeneous alignment direction of the liquid crystal molecules 12 at an angle of substantially 45° in one direction. The rear side polarizing plate 16 is disposed so that its absorption axis 16a is directed to intersect with the homogeneous alignment direction of the liquid crystal molecules 12 at an angle of substantially 45° in the other direction, that is, substantially perpendicularly to the absorption axis 15a of the observation side polarizing plate 15.

Furthermore, the first λ/4 plate 17 is disposed so that its slow axis 17a is directed substantially perpendicularly to one of two directions intersecting with the absorption axis 15a of the observation side polarizing plate 15 at an angle of substantially 45°, for example, the homogeneous aligning treatment direction of the liquid crystal molecules 12. The second λ/4 plate 18 is disposed so that its slow axis 18a is directed substantially perpendicularly to the slow axis 17a of the first λ/4 plate 17.

Moreover, the observation side polarizing plate 15 and the first λ/4 plate 17 are stacked on and affixed to each other, and are arranged in a closely contacted state on the surface of the protective plate 25 that faces the liquid crystal element 1. The liquid crystal element 1 and the first λ/4 plate 17 are arranged to leave a space in between.

In addition, the second λ/4 plate 18 is disposed to be in close contact with or in proximity to the outer surface of the rear side substrate 3 of the liquid crystal element 1. The rear side polarizing plate 16 is stacked on or disposed in proximity to the second λ/4 plate 18.

Here, the first λ/4 plate 17 is preferably disposed as an optical film proximate to the transparent substrate 2 between the transparent substrate 2 and the protective plate 25.

The surface light source 19 is composed of a light guide plate 20 and a plurality of light-emitting elements 24. The light guide plate 20 is made of a transparent plate-shaped member, and has an entrance end face 21 formed on its end face where a light enters, an exit surface 22 formed on one of its two surfaces for the light that has entered from the entrance end face 21, and a reflecting surface 23 formed on its other surface to reflect, to the exit surface 22, the light that has entered from the entrance end face 21. The exit surface 22 is disposed to be directed toward the liquid crystal element 1. The plurality of light-emitting elements 24 are made of, for example, light-emitting diodes (LEDs) arranged face to face with the entrance end face 21 of the light guide plate 20. Exit lights from the plurality of light-emitting elements 24 are guided by the light guide plate 20 to radiate an illumination light from the entire exit surface 22 of the light guide plate 20 toward the liquid crystal element 1.

This display apparatus performs reflection display using an external light that is a light in an external environment, and transmission display using the illumination light from the surface light source 19. The plurality of light-emitting elements 24 of the surface light source 19 are turned on when the transmission display is performed.

The reflection display is first explained. As shown in FIG. 2, a light (external light) a that has entered from the observation side penetrates the protective plate 25, the observation side polarizing plate 15 and the first λ/4 plate 17, and then enters the liquid crystal element 1. Out of this light, a light that has entered the reflection portions D1 of the plurality of pixels D penetrates the liquid crystal layer 11, and is thus reflected by the reflection film 8, and then again penetrates the liquid crystal layer 11. Further, this light penetrates the first λ/4 plate 17 and thus enters the observation side polarizing plate 15. Out of this light, a linearly polarized light component perpendicular to the absorption axis 15a of the observation side polarizing plate 15 penetrates the observation side polarizing plate 15, and then penetrates the protective plate 25 and exits to the observation side.

In addition, out of the light that has entered the liquid crystal element 1, a light that has entered the transmission potions D2 of the plurality of pixels D penetrates the liquid crystal layer 11 and then exits to the rear side of the liquid crystal element 1. This light further penetrates the second λ/4 plate 18 and the rear side polarizing plate 16, and then exits toward the surface light source 19.

In this reflection display, the light that has entered from the observation side and penetrated the protective plate 25 allows its linearly polarized light component parallel to the absorption axis 15a of the observation side polarizing plate 15 to be absorbed by the observation side polarizing plate 15, and becomes a linearly polarized light perpendicular to the absorption axis 15a of the observation side polarizing plate 15, and then enters the first λ/4 plate 17. The first λ/4 plate 17 provides the light with a quarter-wavelength phase difference, so that the light becomes a circularly polarized light and then enters the liquid crystal element 1.

In the case of no electric field where no voltage is applied across the electrodes 4, 5 of the liquid crystal element 1, that is, in the case where the liquid crystal molecules 12 are in homogeneous alignment, the circularly polarized light that has entered the reflection portions D1 of the plurality of pixels D of the liquid crystal element 1 is provided with a quarter-wavelength phase difference while penetrating the liquid crystal layer 11 toward the rear side, and is further provided with a quarter-wavelength phase difference while penetrating the liquid crystal layer 11 toward the observation side. Thus, this circularly polarized light becomes a circularly polarized light having a 3λ/4 phase difference, and then enters the first λ/4 plate 17. The phase difference of the first λ/4 plate 17 further provides the light with a λ/4 phase difference, so that the light becomes a linearly polarized light perpendicular to the absorption axis 15a of the observation side polarizing plate 15 and then enters the observation side polarizing plate 15.

Thus, in the case of no electric field, the light that has penetrated the liquid crystal layer 11 both ways and further penetrated the first λ/4 plate 17 penetrates the observation side polarizing plate 15, and further penetrates the protective plate 25 and then exits to the observation side, such that the display of the pixels with no electric field results in bright display.

Furthermore, if a voltage is applied across the electrodes 4, 5 of the liquid crystal element 1 so that the liquid crystal molecules 12 are aligned to stand up substantially perpendicularly to the surfaces of the substrates 2, 3, the phase difference of the liquid crystal layer 11 substantially becomes zero. Thus, the circularly polarized light that has entered the reflection portions D1 of the plurality of pixels D of the liquid crystal element 1 penetrates the liquid crystal layer 11 both ways without changing the polarization state, and then enters the first λ/4 plate 17. The circularly polarized light is transformed into a linearly polarized light parallel to the absorption axis 15a of the observation side polarizing plate 15 by the phase difference of the first λ/4 plate 17, and then enters the observation side polarizing plate 15.

Therefore, when the voltage is applied, the light that has penetrated the liquid crystal layer 11 both ways and further penetrated the first λ/4 plate 17 is absorbed by the observation side polarizing plate 15, such that the display of the pixels to which the voltage is applied results in dark display.

The transmission display is explained next. As shown in FIG. 2, a light b that has radiated from the surface light source 19 penetrates the rear side polarizing plate 16 and the second λ/4 plate 18, and then enters the liquid crystal element 1. Out of this light, a light that has entered the transmission potions D2 of the plurality of pixels D penetrates the liquid crystal layer 11, and further penetrates the first λ/4 plate 17 and thus enters the observation side polarizing plate 15. The linearly polarized light perpendicular to the absorption axis 15a of the observation side polarizing plate 15 penetrates the observation side polarizing plate 15, and then penetrates the protective plate 25 and exits to the observation side.

In addition, out of the light that has entered the liquid crystal element 1, a light that has entered the reflection portions D1 of the plurality of pixels D is reflected by the reflection film 8, and penetrates the second λ/4 plate 18 and the rear side polarizing plate 16, and then exits toward the surface light source 19. The light is reflected by the surface light source 19, and again exits toward the rear side polarizing plate 16.

In this transmission display, the light radiated from the surface light source 19 allows its linearly polarized light component parallel to the absorption axis 16a of the rear side polarizing plate 16 to be absorbed by the rear side polarizing plate 16, and becomes a linearly polarized light perpendicular to the absorption axis 16a of the rear side polarizing plate 16, and then enters the second λ/4 plate 18. The second λ/4 plate 18 provides the light with a quarter-wavelength phase difference, so that the light becomes a circularly polarized light and then enters the liquid crystal element 1.

In the case of no electric field where no voltage is applied across the electrodes 4, 5 of the liquid crystal element 1 (in the case where the liquid crystal molecules 12 are in homogeneous alignment), the circularly polarized light that has entered the transmission potions D2 of the plurality of pixels D of the liquid crystal element 1 is provided with a half-wavelength phase difference while penetrating the liquid crystal layer 11 toward the observation side.

Thus, in the case of no electric field, the circularly polarized light that has penetrated the liquid crystal layer 11 and thus has a 3λ/4 phase difference is further provided with a λ/4 phase difference by the phase difference of the first λ/4 plate 17, and thus becomes a linearly polarized light perpendicular to the absorption axis 15a of the observation side polarizing plate 15. This light penetrates the observation side polarizing plate 15, and further penetrates the protective plate 25, and then exits to the observation side, such that the display of the pixels with no electric field results in bright display.

Furthermore, if a voltage is applied across the electrodes 4, 5 of the liquid crystal element 1 so that the liquid crystal molecules 12 are aligned to stand up substantially perpendicularly to the surfaces of the substrates 2, 3, the phase difference of the liquid crystal layer 11 substantially becomes zero. Thus, the circularly polarized light that has entered the transmission potions D2 of the plurality of pixels D of the liquid crystal element 1 penetrates the liquid crystal layer 11 without changing the polarization state, and then enters the first λ/4 plate 17. The circularly polarized light is transformed into a linearly polarized light parallel to the absorption axis 15a of the observation side polarizing plate 15 by the phase difference of the first λ/4 plate 17, and then enters the observation side polarizing plate 15.

Therefore, when the voltage is applied, the light that has penetrated the liquid crystal layer 11 and further penetrated the first λ/4 plate 17 is absorbed by the observation side polarizing plate 15, such that the display of the pixels to which the voltage is applied results in dark display.

Although the observation side polarizing plate 15 and the rear side polarizing plate 16 are arranged so that their absorption axes 15a, 16a are substantially perpendicular to each other in this embodiment, the observation side polarizing plate 15 and the rear side polarizing plate 16 may be arranged so that their absorption axes 15a, 16a are substantially parallel to each other. In this case, in both the reflection display and the transmission display, the display of the pixels with no electric field results in dark display, and the display of the pixels to which the voltage is applied results in bright display.

This display apparatus is mounted on electronic equipment such as a mobile telephone, a digital camera or an electronic dictionary. The liquid crystal element 1, the second λ/4 plate 18, the rear side polarizing plate 16 and the surface light source 19 are arranged in the main body of the equipment provided with a display window so that the observation-side surface (the outer surface of the observation side substrate 2) of the liquid crystal element 1 faces the display window. The protective plate 25 is installed at the display window of the main body of the equipment so that the observation side polarizing plate 15 and the first λ/4 plate 17 are stacked in a closely contacted state on the surface of the protective plate 25 that faces the liquid crystal element 1.

Furthermore, in this display apparatus, the observation side polarizing plate 15 and the first λ/4 plate 17 are stacked on each other and arranged in a closely contacted state on the surface of the protective plate 25 that faces the liquid crystal element 1, and the liquid crystal element 1 and the first λ/4 plate 17 are arranged to leave a space in between. Consequently, in both the reflection display and the transmission display, surface reflection can be sufficiently reduced, and display with high contrast can be performed.

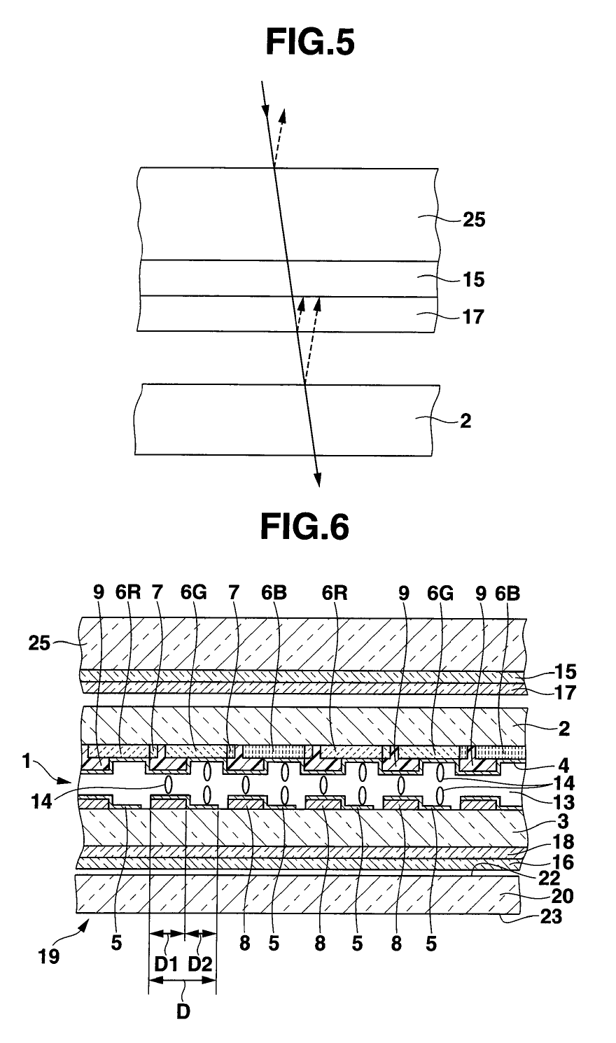

That is, FIG. 5 is a view of a reflected light of the light that has entered from the observation side of the display apparatus. The light that has entered from the observation side is mainly reflected by interfaces having great refractive index differences, that is, part of the light is reflected by the surface of the protective plate 25, by the inner surface (an interface between the first λ/4 plate 17 and an air layer that is disposed between the first λ/4 plate 17 and the liquid crystal element 1), which faces the liquid crystal element 1, of the first λ/4 plate 17 stacked in a closely contacted state via the observation side polarizing plate 15 on the surface of the protective plate 25 that faces the liquid crystal element 1, and by the outer surface of the observation side substrate 2 of the liquid crystal element 1, as indicated by broken arrow lines in FIG. 5.

In addition, at the interface between the protective plate 25 and the observation side polarizing plate 15 for the light that has entered from the observation side and at the interface between the observation side polarizing plate 15 and the first λ/4 plate 17, the difference of the refractive indexes of their adjacent optical media is a small value, so that the intensity of the reflected light at these interfaces is low. Thus, here, the reflection of the light at the interface between the protective plate 25 and the observation side polarizing plate 15 and at the interface between the observation side polarizing plate 15 and the first λ/4 plate is neglected.

Both the light reflected by the inner surface of the first λ/4 plate 17 that faces the liquid crystal element 1 and the light reflected by the outer surface of the observation side substrate 2 of the liquid crystal element 1 are light that has entered from the observation side, penetrated the observation side polarizing plate 15 to become linearly polarized light perpendicular to the absorption axis 15a of the observation side polarizing plate 15, and penetrated the first λ/4 plate 17 to be thus provided with a λ/4 phase difference. These reflected lights (circularly polarized lights) again penetrate the first λ/4 plate 17 to be further provided with a λ/4 phase difference. Accordingly, the reflected lights that enter the observation side polarizing plate 15 become linearly polarized lights having a λ/2 phase difference and parallel to the absorption axis 15a of the observation side polarizing plate 15, so as to be absorbed by the observation side polarizing plate 15.

As a result, the reflected light that has entered from the observation side and has been reflected, on a path to enter the liquid crystal element 1, by the inner surface of the first λ/4 plate 17 that faces the liquid crystal element 1 and by the outer surface of the observation side substrate 2 of the liquid crystal element 1 is absorbed by the observation side polarizing plate 15 and does not exit to the observation side. Thus, surface reflection can be sufficiently reduced, and display with high contrast can be performed.

### Second Embodiment

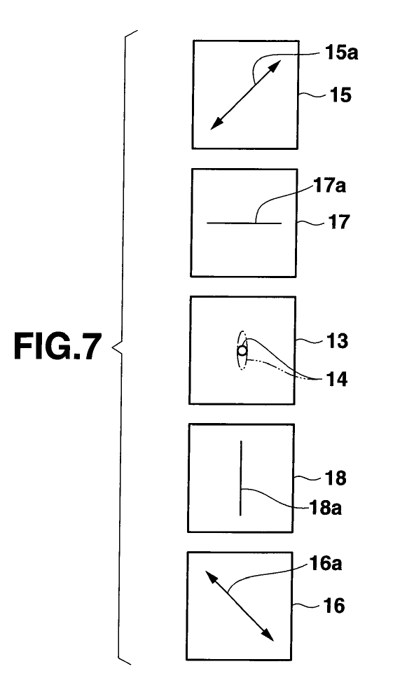

FIG. 6 and FIG. 7 show a second embodiment of the invention. FIG. 6 is a partially enlarged sectional view of a display apparatus. It is to be noted that, in this embodiment, parts equivalent to the parts in the first embodiment described above are provided with the same reference numerals in the drawings, and the same parts are not described.

The display apparatus according to this embodiment comprises a vertical alignment type liquid crystal element 1a as a liquid crystal element: A liquid crystal layer 13 made of nematic liquid crystal having negative dielectric anisotropy is sealed in a space between a pair of substrates 2, 3. The major axes of liquid crystal molecules 14 of the liquid crystal layer 13 are aligned in a direction substantially perpendicular to the surfaces of the substrates 2, 3, and are aligned in a fallen state in a predetermined direction by the application of a voltage across electrodes 4, 5 (the application of a voltage to the liquid crystal layer 13). This display apparatus is the same in configuration as the display apparatus in the first embodiment except for the liquid crystal layer 13. That is, in the liquid crystal element of the display apparatus according to this embodiment, the liquid crystal molecules 14 of the liquid crystal layer 13 are aligned perpendicularly to the surfaces of the substrates when no voltage is applied to the liquid crystal layer 13.

In this embodiment, the inner surfaces of the pair of substrates 2, 3 of the liquid crystal element 1a form homeotropic alignment films (not shown) to cover the electrodes 4, 5, and the surfaces of these alignment films are subjected to an aligning treatment by being rubbed in a direction that determines the direction in which the liquid crystal molecules 14 fall down in response to the application of a voltage across the electrodes 4, 5 (in parallel to each other and in opposite directions).

In addition, this liquid crystal element 1a is a reflection/transmission type element in which a reflection portion D1 and a transmission potion D2 are formed in each of a plurality of pixels D. The thickness of the liquid crystal layer of the reflection portion D1 is set at substantially half the thickness of the liquid crystal layer of the transmission potion D2. Moreover, Δnd of the reflection portion D1 and the transmission potion D2 is set at a value that provides the light that penetrates the liquid crystal layer 13 in one direction with a quarter-wavelength phase difference (a half-wavelength phase difference after both-way passages) in the reflection portion D1 and with a half-wavelength phase difference in the transmission potion D2 when the liquid crystal molecules 14 are aligned in a fallen state.

FIG. 7 shows the alignment state of the liquid crystal molecule 14 of the liquid crystal element 1a, the directions of absorption axes 15a, 16a of observation side and rear side polarizing plates 15, 16, and the directions of slow axes 17a, 18a of first and second λ/4 plates 17, 18.

As shown in FIG. 7, the liquid crystal molecule 14 of the liquid crystal layer 13 of the liquid crystal element 1a is aligned so that its major axis is directed substantially perpendicularly to the surfaces of the substrates 2, 3. As indicated by two-dot chain lines in FIG. 7, the major axis of the molecule is aligned in a fallen state in a predetermined direction, that is, the aligning treatment direction of the pair of substrates 2, 3 (the vertical direction of the screen of the display apparatus in FIG. 7) by the application of a voltage across the electrodes 4, 5.

Furthermore, the observation side polarizing plate 15 is disposed so that its absorption axis 15a intersects with the falling direction (the vertical direction of the screen) of the liquid crystal molecules 14 at an angle of substantially 45° in one direction. The rear side polarizing plate 16 is disposed so that its absorption axis 16a is directed to intersect with the falling direction of the liquid crystal molecules 14 at an angle of substantially 45° in another direction, that is, substantially perpendicularly to the absorption axis 15a of the observation side polarizing plate 15.

The first λ/4 plate 17 is disposed so that its slow axis 17a is directed substantially perpendicularly to one of two directions intersecting with the absorption axis 15a of the observation side polarizing plate 15 at an angle of substantially 45°, for example, substantially perpendicularly to the falling direction of the liquid crystal molecules 14. The second λ/4 plate 18 is disposed so that its slow axis 18a is directed substantially perpendicularly to the slow axis 17a of the first λ/4 plate 17.

Moreover, the observation side polarizing plate 15 and the first λ/4 plate 17 are stacked on each other and arranged in a closely contacted state on the surface of the protective plate 25 that faces the liquid crystal element 1. The liquid crystal element 1 and the first λ/4 plate 17 are arranged to leave a space in between.

In the display apparatus according to this embodiment, the liquid crystal molecules 14 of the liquid crystal layer 13 of the liquid crystal element 1a are aligned so that their major axes are directed substantially perpendicularly to the surfaces of the substrates 2, 3, and the major axes of the molecules are aligned in a fallen state in the predetermined direction by the application of a voltage across electrodes 4, 5. Thus, in both the reflection display using an external light and the transmission display using an illumination light from a surface light source 19, the display of the pixels with no electric field results in bright display, and the display of the pixels to which the voltage is applied results in bright display.

In addition, in this embodiment, the observation side polarizing plate 15 and the rear side polarizing plate 16 may be arranged so that their absorption axes 15a, 16a are substantially parallel to each other. In this case, in both the reflection display and the transmission display, the display of the pixels with no electric field results in bright display, and the display of the pixels to which the voltage is applied results in dark display.

Furthermore, in this display apparatus, the observation side polarizing plate 15 and the first λ/4 plate 17 are stacked on each other and arranged in a closely contacted state on the surface of the protective plate 25 that faces the liquid crystal element 1, and the liquid crystal element 1 and the first λ/4 plate 17 are arranged to leave a space in between. Consequently, as in the display apparatus according to the first embodiment described above, the reflection of the light entering from the observation side can be sufficiently reduced, and display with high contrast can be performed.

### Application of First and Second Embodiments

The display apparatuses in the first and second embodiments described above are a

reflection/transmission type for performing the reflection display and the transmission display. However, these embodiments are not limited to the reflection/transmission type display apparatus, and are also applicable to both a reflection type display apparatus for only performing the reflection display using the external light and a transmission type display apparatus for only performing the transmission display using the illumination light from the surface light source 19.

That is, in the case of the reflection type display apparatus, the observation side polarizing plate 15 and the λ/4 plate 17 may be arranged on the observation side of the liquid crystal element 1, 1a as in the first and second embodiments. The liquid crystal element 1, 1a may be configured so that the reflection film 8 is formed face to face with the whole regions of the plurality of pixels D and so that Δnd of the liquid crystal layer 11, 13 is set, in the whole regions of the plurality of pixels D, at the same value as that of Δnd of the reflection portion D1 in the first and second embodiments. In the case of this reflection type display apparatus, the rear side polarizing plate 16, the second λ/4 plate 18 and the surface light source 19 in the first and second embodiments are not necessary.

In the case of the transmission type display apparatus, the observation side and opposite polarizing plates 15, 16 and the first and second λ/4 plates 17, 18 are arranged in the same way as in the first and second embodiments. The liquid crystal element 1, 1a may be configured so that the reflection film 8 and the liquid crystal layer thickness adjusting film 9 are not provided and so that Δnd of the liquid crystal layer 11, 13 is set, in the whole regions of the plurality of pixels D, at the same value as that of Δnd of the transmission potion D2 in the first and second embodiments.

Furthermore, the arrangement of the observation side and opposite polarizing plates 15, 16 and the first and second λ/4 plates 17, 18 in the first and second embodiments can be applied not only to the display apparatus having the homogeneous alignment type or vertical alignment type liquid crystal element 1, 1a but also to display apparatuses having other types of liquid crystal elements.

### Third Embodiment

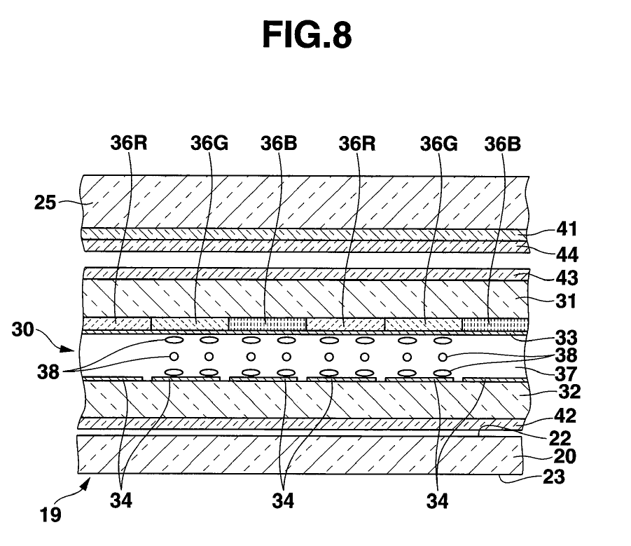

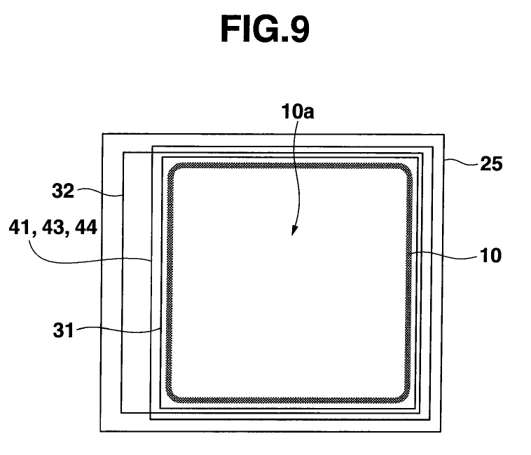

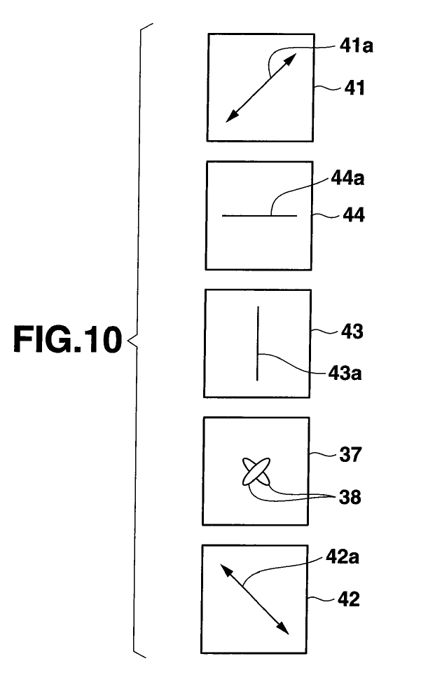

FIG. 8, FIG. 9 and FIG. 10 show a third embodiment of the invention. FIG. 8 is a partially enlarged sectional view of a display apparatus. FIG. 9 is a schematic plan view of the display apparatus. It is to be noted that a surface light source 19 and a protective plate 25 in this embodiment are the same as the surface light source 19 and the protective plate 25 in the first embodiment.

As shown in FIG. 8 and FIG. 9, the display apparatus according to this embodiment comprises: a liquid crystal element 30; an observation side polarizing plate 41 that has an absorption axis 41a (see FIG. 10) in a direction predetermined in accordance with the alignment state of liquid crystal molecules 38 of a liquid crystal layer 37 of the liquid crystal element 30 and that is disposed on the observation side of the liquid crystal element 30; a rear side polarizing plate 42 that has an absorption axis 42a (see FIG. 10) in a direction substantially perpendicular or parallel to the absorption axis 41a of the observation side polarizing plate 41 and that is disposed on the side of the liquid crystal element 30 opposite to the observation side; a first λ/4 plate (quarter-wavelength retardation plate) 43 that has a slow axis 43a (see FIG. 10) in a direction intersecting with the absorption axis 41a of the observation side polarizing plate 41 at an angle of substantially 45° and that is disposed between the liquid crystal element 30 and the observation side polarizing plate 41; a second λ/4 plate 44 that has a slow axis 44a (see FIG. 10) in a direction substantially perpendicular to the slow axis 43a of the first λ/4 plate 43 and that is disposed between the observation side polarizing plate 41 and the first λ/4 plate 43; a surface light source 19 that is disposed on the rear side of the liquid crystal element 30; and a protective plate 25 disposed closer to the observation side than the observation side polarizing plate 41.

In the liquid crystal element 30, a liquid crystal layer 37 in which liquid crystal molecules 38 are aligned in a predetermined alignment state is sealed in a space between a pair of observation side and opposite transparent substrates 31, 32 that are arranged face to face to leave a predetermined space in between. Transparent electrodes 33, 34 are provided on at least one of the inner surfaces of the pair of substrates 31, 32 that face each other. The transparent electrodes 33, 34 form a plurality of pixels that change the alignment state of the liquid crystal molecules in response to the application of a voltage to control the transmission of a light. The pair of substrates 31, 32 are joined together via a frame-shaped seal material 10. The liquid crystal layer 37 is sealed in the space enclosed by the seal material between the pair of substrates 31, 32. In addition, the transparent substrate 32 is greater in area than the transparent substrate 31. Moreover, the protective plate 25 is greater in area than the transparent substrate 31.

In this embodiment, the liquid crystal element 30 is a twisted nematic (TN) type element: The electrodes 33, 34 are provided on the respective inner surfaces of the pair of substrates 31, 32 to form a plurality of pixels by regions that face each other. The liquid crystal layer 37 made of nematic liquid crystal having positive dielectric anisotropy is sealed in a space between the pair of substrates 31, 32. The liquid crystal molecules 38 of the liquid crystal layer 37 are in twist alignment at a twisted angle of substantially 90° between the pair of substrates 31, 32 so that the major axes of these molecules are directed substantially in parallel to the surfaces of the substrates 31, 32, and the liquid crystal molecules 38 are aligned to stand up on the surfaces of the substrates 31, 32 by the application of a voltage across the electrodes 33, 34.

In addition, the liquid crystal element 30 is an active matrix liquid crystal element using a TFT as an active element. The electrode 33 provided on the inner surface of the observation side substrate 31 is an opposed electrode in the form of a single film. The electrodes 34 provided on the inner surface of the rear side substrate (the substrate on the side opposite to the observation side) 32 are a plurality of pixel electrodes that are formed to be arranged in a row direction and a column direction.

Although not shown in FIG. 8, a plurality of TFTs, a plurality of scanning lines and a plurality of signal lines are provided on the inner surface of the rear side substrate 32. The plurality of TFTs are connected to the plurality of pixel electrodes 34, respectively. The plurality of scanning lines supply gate signals to the TFTs in the respective rows. The plurality of signal lines supply data signals to the TFTs in the respective columns. Further, red, green and blue three color filters 36R, 36G, 36B are provided on the inner surface of the observation side substrate 31 to correspond to the plurality of pixels. The electrode 33 is formed on the color filters 36R, 36G, 36B.

In addition, this liquid crystal element 30 is a transmission type element that transmits, in the whole region of each of the plurality of pixels, a light entering from the side opposite to the observation side (a light radiated from the surface light source 19) and causes the light to exit to the observation side.

Although not shown in FIG. 8, the inner surfaces of the pair of substrates 31, 32 form homogeneous alignment films (not shown) to cover the electrodes 33, 34, and the surfaces of these alignment films are subjected to an aligning treatment by being rubbed in a direction perpendicular to each other. The liquid crystal molecules 38 of the liquid crystal layer 37 are in twist alignment in the vicinity of the pair of substrates 31, 32 at a twisted angle of substantially 90° between the pair of substrates 31, 32 so that their major axes are pretilted at an angle of about 1° to 5° to the surfaces of the substrates 31, 32 toward the aligning treatment direction of the substrates 31, 32. That is, when no voltage is applied to the liquid crystal layer 37, the liquid crystal molecules 38 of the liquid crystal layer 37 are in twist alignment at a twisted angle of substantially 90°.

FIG. 10 shows the alignment state of the liquid crystal molecules 38 of the liquid crystal element 30, the directions of the absorption axes 41a, 42a of the observation side and rear side polarizing plates 41, 42, and the directions of the slow axes 43a, 44a of the first and second λ/4 plates 43, 44.

As shown in FIG. 10, the liquid crystal molecules 38 of the liquid crystal layer 37 of the liquid crystal element 30 are in twist alignment so that their major axes are directed to intersect with the vertical direction of the screen of the display apparatus at an angle of 45° in opposite directions in the vicinity of the pair of substrates 31, 32. The observation side polarizing plate 41 is disposed so that its absorption axis 41a is directed substantially in parallel or perpendicularly to the alignment direction of the liquid crystal molecules 38 in the vicinity of the observation side substrate 31 to which the observation side polarizing plate 41 of the liquid crystal element 30 is adjacent. The rear side polarizing plate 42 is disposed so that its absorption axis 42a is directed substantially in parallel or perpendicularly to the alignment direction of the liquid crystal molecules 38 in the vicinity of the rear side substrate 32 to which the rear side polarizing plate 42 of the liquid crystal element 30 is adjacent. In addition, in this embodiment, the absorption axis 41a of the observation side polarizing plate 41 is substantially parallel to the alignment direction of the liquid crystal molecules 38 in the vicinity of the observation side substrate 31, and the absorption axis 42a of the rear side polarizing plate 42 is substantially perpendicular to the absorption axis 41a of the observation side polarizing plate 41. Moreover, each of the observation side polarizing plate 41 and the rear side polarizing plate 42 has an area greater than that of the region 10a enclosed by the seal material 10, that is, has an area greater than that of a display area for displaying images.

Furthermore, of the first and second λ/4 plates 43, 44, the first λ/4 plate 43 on the side of the liquid crystal element 30 is disposed so that its slow axis 43a is directed substantially in parallel to one of two directions intersecting with the absorption axis 41a of the observation side polarizing plate 41 at an angle of substantially 45°, for example, the alignment direction of the liquid crystal molecules 38 in the vicinity of the observation side substrate 31 of the liquid crystal element 30. The second λ/4 plate 44 on the side of the protective plate 25 is disposed so that its slow axis 44a is directed substantially perpendicularly to the slow axis 43a of the first λ/4 plate 43. That is, the first and second λ/4 plates 43, 44 are arranged so that their slow axes 43a, 44a are perpendicular to each other. In addition, each of the first and second λ/4 plates 43, 44 has an area greater than that of the region 10a enclosed by the seal material 10.

The first λ/4 plate 43 is disposed to be in close contact with the outer surface of the observation side polarizing plate 41 of the liquid crystal element 30. The observation side polarizing plate 41 and the second λ/4 plate 44 are stacked on each other and arranged in a closely contacted state on the surface of the protective plate 25 that faces the liquid crystal element 30. Moreover, the first λ/4 plate 43 and the second λ/4 plate 44 are arranged to leave a predetermined space in between. In addition, the rear side polarizing plate 42 is disposed to be in close contact with the outer surface of the rear side substrate 32 of the liquid crystal element 30 or in proximity to the outer surface of the rear side substrate 32.

Here, the second λ/4 plate 44 is preferably disposed as an optical film proximate to the first λ/4 plate 43 between the first λ/4 plate 43 and the protective plate 25.

This display apparatus performs transmission display by radiating an illumination light from the surface light source 19. The light radiated from the surface light source 19 allows its linearly polarized light component parallel to the absorption axis 42a of the rear side polarizing plate 42 to be absorbed by the rear side polarizing plate 42, and becomes a linearly polarized light perpendicular to the absorption axis 42a of the rear side polarizing plate 42, and then enters the liquid crystal element 30.

In the case of no electric field where no voltage is applied across the electrodes 33, 34 of the liquid crystal element 30 (in the case where the liquid crystal molecules 12 are in twist alignment), the linearly polarized light that has entered the plurality of pixels of the liquid crystal element 30 is rotated substantially 90° while penetrating the liquid crystal layer 37 toward the observation side. Thus, this linearly polarized light becomes a linearly polarized light parallel to the absorption axis 42a of the rear side polarizing plate 42 and then exits to the observation side of the liquid crystal element 30.

The linearly polarized light (the linearly polarized light parallel to the absorption axis 42a of the rear side polarizing plate 42) that has been rotated substantially 90° by the liquid crystal layer 37 and exited from the liquid crystal element 30 penetrates the first λ/4 plate 43 and the second λ/4 plate 44 having their slow axes 43a, 44a that intersect perpendicularly to each other. Thus, this linearly polarized light remains as the linearly polarized light perpendicular to the absorption axis 41a of the observation side polarizing plate 41 and enters the observation side polarizing plate 41 without changing the polarization state.

Thus, in the case of no electric field, the light that has exited from the liquid crystal element 30 and penetrated the first λ/4 plate 43 and the second λ/4 plate 44 penetrates the observation side polarizing plate 41, and further penetrates the protective plate 25 and exits to the observation side, such that the display of the pixels with no electric field results in bright display.

Furthermore, if a voltage is applied across the electrodes 33, 34 of the liquid crystal element 30 so that the liquid crystal molecules 38 are aligned to stand up substantially perpendicularly to the surfaces of the substrates 31, 32, the linearly polarized light that has penetrated the rear side polarizing plate 42 and entered the liquid crystal element 30 penetrates the liquid crystal layer 37 without changing the polarization state, and then exits to the observation side of the liquid crystal element 30.

The linearly polarized light that has penetrated the liquid crystal layer 37 without changing the polarization state and then exited to the observation side of the liquid crystal element 30 (the linearly polarized light perpendicular to the absorption axis 42a of the rear side polarizing plate 42) penetrates the first λ/4 plate 43 and the second λ/4 plate 44 having their slow axes 43a, 44a that intersect perpendicularly to each other. Thus, this linearly polarized light remains as the linearly polarized light parallel to the absorption axis 41a of the observation side polarizing plate 41 and enters the observation side polarizing plate 41 without changing the polarization state.

Therefore, when the voltage is applied, the light that has exited from the liquid crystal element 30 and penetrated the first λ/4 plate 43 and the second λ/4 plate 44 is absorbed by the observation side polarizing plate 41, such that the display of the pixels to which the voltage is applied results in dark display.

Although the observation side polarizing plate 41 and the rear side polarizing plate 42 are arranged so that their absorption axes 41a, 42a are substantially perpendicular to each other in this embodiment, the observation side polarizing plate 41 and the rear side polarizing plate 42 may be arranged so that their absorption axes 41a, 42a are substantially parallel to each other. In this case, the display of the pixels with no electric field results in dark display, and the display of the pixels to which the voltage is applied results in bright display.

Furthermore, in this display apparatus, the first λ/4 plate 43 is disposed to be in close contact with the outer surface of the observation side substrate 31 of the liquid crystal element 30. The observation side polarizing plate 41 and the second λ/4 plate 44 are stacked on each other and arranged in a closely contacted state on the surface of the protective plate 25 that faces the liquid crystal element 30. Moreover, the first λ/4 plate 43 and the second λ/4 plate 44 are arranged to leave a predetermined space in between. Consequently, the reflection of the light entering from the observation side can be sufficiently reduced, and display with high contrast can be performed.

That is, part of the light that has entered this display apparatus from the observation side is reflected by interfaces having great refractive index differences, that is, by the surface of the protective plate 25, by the surface of the second λ/4 plate 44 that faces the first λ/4 plate 43 and by the surface of the first λ/4 plate 43 that faces the second λ/4 plate 44 in the process of entering the liquid crystal element 30 after penetrating the observation side polarizing plate 41 that is stacked in a closely contacted state on the surface of the protective plate 25 that faces the liquid crystal element 30, penetrating the second λ/4 plate 44 stacked in a closely contacted state on the observation side polarizing plate 41 and penetrating the first λ/4 plate 43 arranged in a closely contacted state on the outer surface of the observation side substrate 31 of the liquid crystal element 30.

In addition, at the interface between the protective plate 25 and the observation side polarizing plate 41, at the interface between the observation side polarizing plate 41 and the second λ/4 plate 44 and at the interface between the first λ/4 plate 43 and the observation side substrate 31 of the liquid crystal element 30, the difference of the refractive indexes of their adjacent optical media is a small value, so that the reflection of the light these interfaces may be neglected.

Among the lights reflected by the above-mentioned interfaces having the great refractive index differences, both the light reflected by the inner surface of the second λ/4 plate 44 that faces the first λ/4 plate 43 and the light reflected by the surface of the first λ/4 plate 43 that faces the second λ/4 plate 44 are light that has entered from the observation side, penetrated the observation side polarizing plate 41 to become linearly polarized light perpendicular to the absorption axis 41a of the observation side polarizing plate 41, and been provided with a λ/4 phase difference by the second λ/4 plate 44 to become circularly polarized light. These reflected lights (circularly polarized lights) again penetrate the second λ/4 plate 44 and are thus provided with a λ/4 phase difference. The reflected lights become linearly polarized lights having a λ/2 phase difference and parallel to the absorption axis 41a of the observation side polarizing plate 41, and are absorbed by the observation side polarizing plate 41.

As a result, the reflected light that has entered from the observation side and has been reflected, on a path to enter the liquid crystal element 30, by the inner surface of the second λ/4 plate 44 that faces the first λ/4 plate 43 and by the surface of the first λ/4 plate 43 that faces the second λ/4 plate 44 is absorbed by the observation side polarizing plate 41 and does not exit to the observation side. Thus, surface reflection can be sufficiently reduced, and display with high contrast can be performed.

### Fourth Embodiment

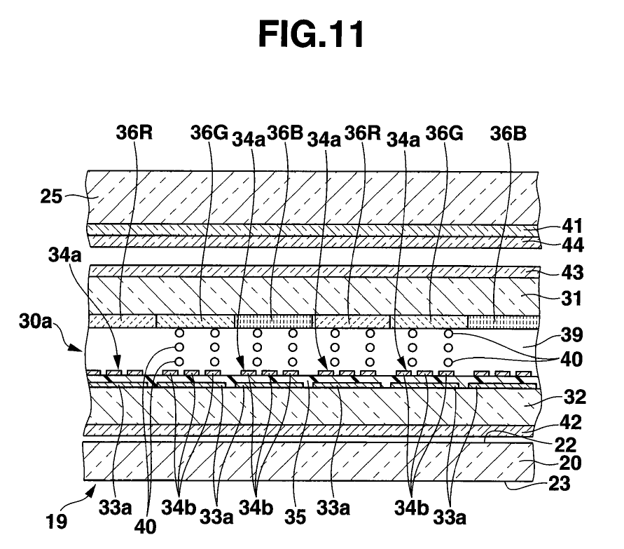

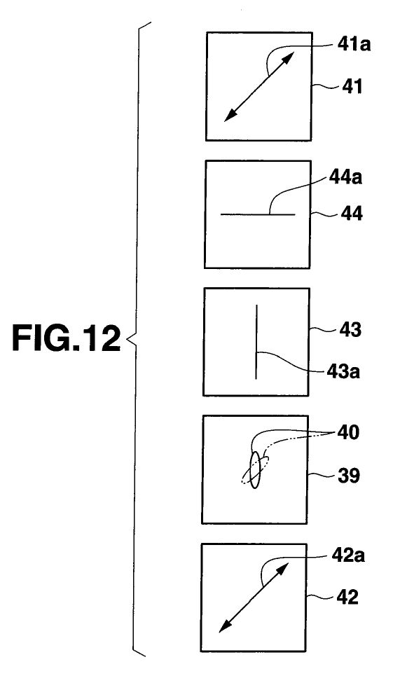

FIG. 11 and FIG. 12 show a fourth embodiment of the invention. FIG. 11 is a partially enlarged sectional view of a display apparatus. It is to be noted that parts in this embodiment equivalent to the parts in the third embodiment described above are provided with the same reference numerals in the drawings, and the same parts are not described.

The display apparatus according to this embodiment comprises a lateral-field control type element 30a as a liquid crystal element: A liquid crystal layer 39 made of nematic liquid crystal having positive dielectric anisotropy is sealed in a space between a pair of substrates 31, 32. On the inner surface of one of the pair of substrates 31, 32, for example, the rear side substrate 32, there are provided a first electrode 33a for forming a plurality of pixels, and a second electrode 34a that is formed closer to the liquid crystal layer 39 than the first electrode 33a in such a manner as to be insulated from the first electrode 33a by an insulating film 35 and that has a plurality of elongate electrode portions 34b. Liquid crystal molecules 40 of the liquid crystal layer 39 are aligned substantially in parallel to the surfaces of the substrates 31, 32 so that their major axes are aligned with the longitudinal direction of the plurality of elongate electrode portions 34b of the second electrode 34a. The direction of the major axes of the molecules are changed to the direction along the surfaces of the substrates 31, 32 by a lateral electric field that is generated across the first and second electrodes 33a, 34a by the application of a voltage across the electrodes 33a, 34a.

Of the first and second electrodes 33a, 34a for forming the plurality of pixels, the first electrode 33a on the side of the rear side substrate 32 is made of, for example, a transparent conductive coating formed into the shape of the pixel. The second electrode 34a on the side of the liquid crystal layer 39 is made of a transparent conductive coating formed into a comb-tooth shape having the plurality of elongate electrode portions 34b.

One of the first and second electrodes 33a, 34a, for example, the plurality of first electrodes 33a on the side of the rear side substrate 32 are connected in common in each row. The other electrodes, that is, the plurality of second electrodes 34a are connected to unshown TFTs that are arranged on the inner surface of the rear side substrate 32 to correspond to the second electrodes 34a. Further, red, green and blue three color filters 6R, 6G, 6B are provided on the inner surface of the observation side substrate 2 to correspond to the plurality of pixels.

Furthermore, the inner surfaces of the pair of substrates 31, 32 form homogeneous alignment films (not shown) to cover the color filters 6R, 6G, 6B and the plurality of second electrodes 34a, and the surfaces of these alignment films are subjected to an aligning treatment by being rubbed substantially in parallel to the longitudinal direction of the plurality of elongate electrode portions 34b of the second electrode 34a (within an angle of about 0° to 10° to the longitudinal direction of the elongate electrode portions 34b) and in directions opposite to each other. The liquid crystal molecules 40 of the liquid crystal layer 39 are aligned in a condition pretilted at an angle of about 1° to 5° to the surfaces of the substrates 31, 32 so that their major axes are aligned substantially in parallel to the aligning treatment direction of the pair of substrates 31, 32, that is, the longitudinal direction of the elongate electrode portions 34b of the second electrode 34a. That is, when no voltage is applied to the liquid crystal layer 39, the liquid crystal molecules 40 of the liquid crystal layer 39 are in homogeneous alignment.

Moreover, Δnd of the liquid crystal layer 39 is set at a value that provides a half-wavelength phase difference to a linearly polarized light having a light vibration plane in a direction intersecting with the alignment direction of the liquid crystal molecules 40 at an angle of 45° when there is no electric field.

In addition, this liquid crystal element 30a is a transmission type element, and is the same in configuration as the liquid crystal element 30 in the third embodiment described above except for the plurality of first and second electrodes 33a, 34a for forming the plurality of pixels and the liquid crystal layer 39.

FIG. 12 shows the alignment state of the liquid crystal molecules 40 of the liquid crystal element 30a, the directions of absorption axes 41a, 42a of observation side and rear side polarizing plates 41, 42, and the directions of slow axes 43a, 44a of first and second λ/4 plates 43, 44.

As shown in FIG. 12, the liquid crystal molecules 40 of the liquid crystal layer 39 of the liquid crystal element 30a are aligned in a condition pretilted at an angle of about 1° to 5° to the surfaces of the substrates 31, 32 so that their major axes are aligned substantially in parallel to the aligning treatment direction of the pair of substrates 31, 32, that is, the longitudinal direction of the elongate electrode portions 34b of the second electrode 34a. As indicated by two-dot chain lines in FIG. 12, the major axes of the molecules are aligned to be changed to the direction along the surfaces of the substrates 31, 32 by a lateral electric field that is generated across the first and second electrodes 33a, 34a by the application of a voltage across the electrodes 33a, 34a.

In addition, the maximum value of the voltage applied across the first and second electrodes 33a, 34a is set at a value that aligns the liquid crystal molecules 40 substantially in a direction of 45° with respect to the no-field alignment direction.

Furthermore, the observation side polarizing plate 41 is disposed so that its absorption axis 41a is directed to intersect with the no-field alignment direction of the liquid crystal molecules 40 at an angle of substantially 45° in one direction. The rear side polarizing plate 42 is disposed so that its absorption axis 42a is directed substantially in parallel to the absorption axis 41a of the observation side polarizing plate 41.

Furthermore, of the first and second λ/4 plates 43, 44, the first λ/4 plate 43 on the side of the liquid crystal element 30a is disposed so that its slow axis 43a is directed substantially in parallel to one of two directions intersecting with the absorption axis 41a of the observation side polarizing plate 41 at an angle of substantially 45°, for example, the alignment direction of the liquid crystal molecules 40 when there is no electric field in the liquid crystal element 30a. The second λ/4 plate 44 on the side of the protective plate 25 is disposed so that its slow axis 44a is directed substantially perpendicularly to the slow axis 43a of the first λ/4 plate 43. That is, the first and second λ/4 plates 43, 44 are arranged so that their slow axes 43a, 44a are perpendicular to each other.

Furthermore, the first λ/4 plate 43 is disposed to be in close contact with the outer surface of the observation side polarizing plate 41 of the liquid crystal element 30a. The observation side polarizing plate 41 and the second λ/4 plate 44 are stacked on each other and arranged in a closely contacted state on the surface of the protective plate 25 that faces the liquid crystal element 30a. Moreover, the first λ/4 plate 43 and the second λ/4 plate 44 are arranged to leave a predetermined space in between. In addition, the rear side polarizing plate 42 is disposed to be in close contact with the outer surface of the rear side substrate 32 of the liquid crystal element 30a or in proximity to the outer surface of the rear side substrate 32.

This display apparatus performs transmission display by radiating an illumination light from a surface light source 19. The light radiated from the surface light source 19 allows its linearly polarized light component parallel to the absorption axis 42a of the rear side polarizing plate 42 to be absorbed by the rear side polarizing plate 42, and becomes a linearly polarized light perpendicular to the absorption axis 42a of the rear side polarizing plate 42, and then enters the liquid crystal element 30a.

In the case of no electric field where no voltage is applied across the first and second electrodes 33a, 34a of the liquid crystal element 30a (in the case where the liquid crystal molecules 40 are directed to intersect with the absorption axis 42a of the rear side polarizing plate 42 at an angle of substantially 45°), the linearly polarized light that has entered the plurality of pixels of the liquid crystal element 30a is provided with a half-wavelength phase difference while penetrating the liquid crystal layer 37 toward the observation side. Thus, this linearly polarized light becomes a linearly polarized light parallel to the absorption axis 42a of the rear side polarizing plate 42 and then exits to the observation side of the liquid crystal element 30a.

The linear light that has exited from the liquid crystal element 30a penetrates the first λ/4 plate 43 and the second λ/4 plate 44 having their slow axes 43a, 44a that intersect perpendicularly to each other. Thus, this linearly polarized light remains as the linearly polarized light parallel to the absorption axis 41a of the observation side polarizing plate 41 and enters the observation side polarizing plate 41 without changing the polarization state.

Therefore, in the case of no electric field, the light that has exited from the liquid crystal element 30a and penetrated the first λ/4 plate 43 and the second λ/4 plate 44 is absorbed by the observation side polarizing plate 41, such that the display of the pixels to which the voltage is applied results in dark display.

Furthermore, if a voltage is applied across the first and second electrodes 33a, 34a of the liquid crystal element 30a to align the liquid crystal molecules 40 with the direction at an angle of substantially 45° to the no-field alignment direction, that is, the direction substantially parallel or perpendicular (parallel in FIG. 12) to the absorption axis 42a of the rear side polarizing plate 42, the linearly polarized light that has penetrated the rear side polarizing plate 42 and entered the liquid crystal element 30a penetrates the liquid crystal layer 39 without changing the polarization state, and then exits to the observation side of the liquid crystal element 30a.

The linearly polarized light that has penetrated the liquid crystal layer 39 without changing the polarization state and then exited to the observation side of the liquid crystal element 30a (the linearly polarized light perpendicular to the absorption axis 42a of the rear side polarizing plate 42) penetrates the first λ/4 plate 43 and the second λ/4 plate 44 having their slow axes 43a, 44a that intersect perpendicularly to each other. Thus, this linearly polarized light remains as the linearly polarized light perpendicular to the absorption axis 41a of the observation side polarizing plate 41 and enters the observation side polarizing plate 41 without changing the polarization state.

Therefore, when the voltage is applied, the light that has exited from the liquid crystal element 30a and penetrated the first λ/4 plate 43 and the second λ/4 plate 44 penetrates the observation side polarizing plate 41, and further penetrates the protective plate 25 and exits to the observation side, such that the display of the pixels to which the voltage is applied results in bright display.

Although the observation side polarizing plate 41 and the rear side polarizing plate 42 are arranged so that their absorption axes 41a, 42a are in parallel to each other in this embodiment, the observation side polarizing plate 41 and the rear side polarizing plate 42 may be arranged so that their absorption axes 41a, 42a are substantially perpendicular to each other. In this case, the display of the pixels with no electric field results in bright display, and the display of the pixels to which the voltage is applied results in dark display.

Furthermore, in this display apparatus, the first λ/4 plate 43 is disposed to be in close contact with the outer surface of the observation side substrate 31 of the liquid crystal element 30. The observation side polarizing plate 41 and the second λ/4 plate 44 are stacked on each other and arranged in a closely contacted state on the surface of the protective plate 25 that faces the liquid crystal element 30a. Moreover, the first λ/4 plate 43 and the second λ/4 plate 44 are arranged to leave a predetermined space in between. Consequently, as in the third embodiment described above, surface reflection can be sufficiently reduced, and display with high contrast can be performed.

### Application of Third and Fourth Embodiments

The arrangement of the observation side and opposite polarizing plates 41, 42 and the first and second λ/4 plates 43, 44 in the third and fourth embodiments is not limited to the display apparatus having the TN type or lateral-field control type element 30, 30a, and is also applicable to display apparatuses having other types of liquid crystal elements.

### Fifth Embodiment

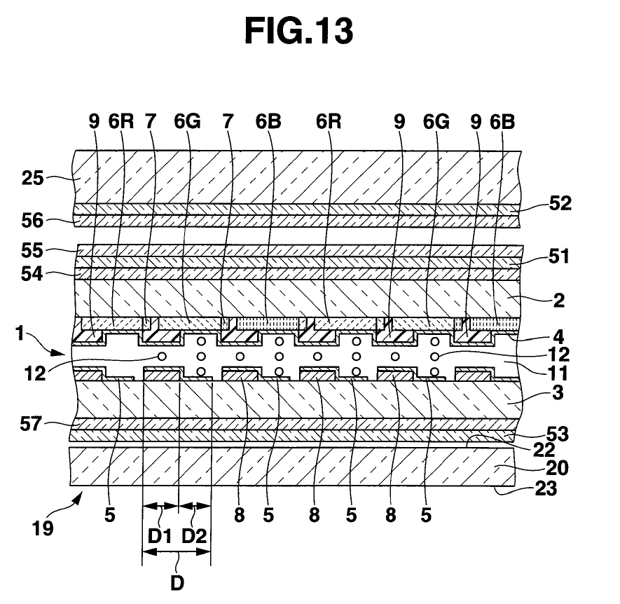

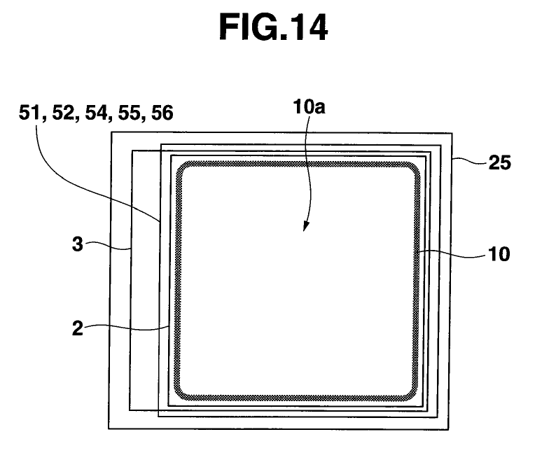

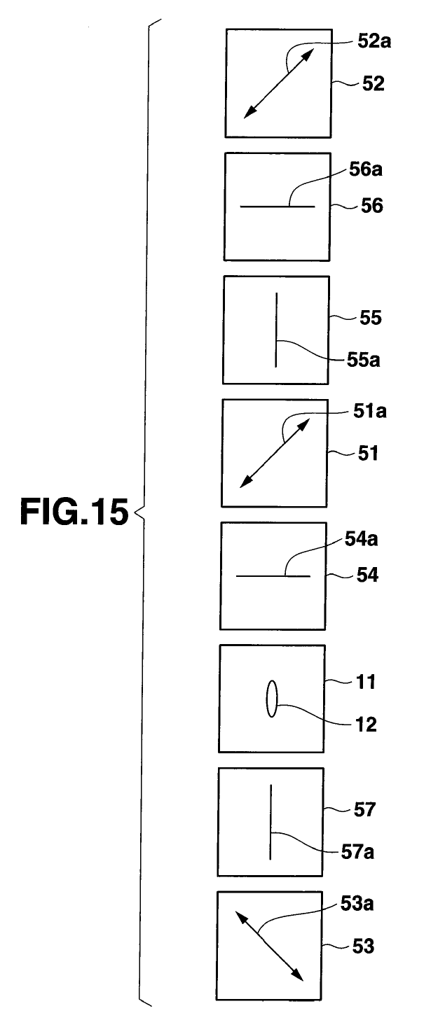

FIG. 13, FIG. 14 and FIG. 15 show a fifth embodiment of the invention. FIG. 13 is a partially enlarged sectional view of a display apparatus. FIG. 14 is a schematic plan view of the display apparatus. It is to be noted that a surface light source 19 and a protective plate 25 in this embodiment are the same as the surface light source 19 and the protective plate 25 in the first embodiment.

As shown in FIG. 13 and FIG. 14, the display apparatus according to this embodiment comprises: a liquid crystal element 1; a first observation side polarizing plate 51 that has an absorption axis 51a (see FIG. 15) in a direction predetermined in accordance with the alignment state of liquid crystal molecules 12 of a liquid crystal layer 11 of the liquid crystal element 1 and that is disposed on the observation side of the liquid crystal element 1; a second observation side polarizing plate 52 that has an absorption axis 52a (see FIG. 15) in a direction substantially parallel to the absorption axis 51a of the first observation side polarizing plate 51 and that is disposed closer to the observation side than the first observation side polarizing plate 51; a rear side polarizing plate 53 that has an absorption axis 53a (see FIG. 15) in a direction substantially perpendicular or parallel to the absorption axis 51a of the first observation side polarizing plate 51 and that is disposed on the side of the liquid crystal element 1 opposite to the observation side; a first λ/4 plate (quarter-wavelength retardation plate) 54 that has a slow axis 54a (see FIG. 15) in a direction intersecting with the absorption axis 51a of the first observation side polarizing plate 51 at an angle of substantially 45° and that is disposed between the liquid crystal element 1 and the first observation side polarizing plate 51; a second λ/4 plate 55 that has a slow axis 55a (see FIG. 15) in a direction substantially perpendicular to the slow axis 54a of the first λ/4 plate 54 and that is disposed closer to the observation side than the first observation side polarizing plate 51; a third λ/4 plate 56 that has a slow axis 56a (see FIG. 15) in a direction substantially perpendicular to the slow axis 55a of the second λ/4 plate 55 and that is disposed between the second observation side polarizing plate 52 and the second λ/4 plate 55; a fourth λ/4 plate 57 that has a slow axis 57a (see FIG. 15) in a direction substantially perpendicular to the slow axis 54a of the first λ/4 plate 54 and that is disposed between the liquid crystal element 1 and the rear side polarizing plate 53; a surface light source 19 that is disposed on the rear side of the rear side polarizing plate 53; and a protective plate 25 disposed closer to the observation side than the second observation side polarizing plate 52.

In this embodiment, the liquid crystal element 1 is a nontwist homogeneous alignment type element as in the first embodiment: A reflection portion D1 and a transmission potion D2 are formed in each of a plurality of pixels D. The reflection portion D1 causes the light that has entered from the observation side to be reflected by the reflection film 8 and then exit to the observation side. The transmission potion D2 transmits the light radiated from the surface light source 19 and causes the light to exit to the observation side.

FIG. 15 shows the alignment state of the liquid crystal molecule 12 of the liquid crystal element 1, the directions of the absorption axes 51a, 52a, 53a of the first and second observation side polarizing plates 51, 52 and the rear side polarizing plate 53, and the directions of the slow axes 54a, 55a, 56a, 57a of the first, second, third and fourth λ/4 plates 54, 55, 56, 57.

As shown in FIG. 13, the liquid crystal molecules 12 of the liquid crystal layer 11 of the liquid crystal element 1 are in homogeneous alignment so that their major axes are aligned in a predetermined direction, for example, the vertical direction of the screen of the display apparatus. The observation side polarizing plate 51 is disposed so that its absorption axis 51a is directed to intersect with the homogeneous alignment direction of the liquid crystal molecules 12 at an angle of substantially 45° in one direction. The rear side polarizing plate 53 is disposed so that its absorption axis 53a is directed to intersect with the homogeneous alignment direction of the liquid crystal molecules 12 at an angle of substantially 45° in the other direction, that is, substantially perpendicularly to the absorption axis 51a of the observation side polarizing plate 51. In addition, each of the first observation side polarizing plate 51, the second observation side polarizing plate 52 and the rear side polarizing plate 53 has an area greater than that of a region 10a enclosed by a seal material 10, that is, has an area greater than that of a display area for displaying images.

Furthermore, the first λ/4 plate 54 is disposed so that its slow axis 54a is directed substantially perpendicularly to one of two directions intersecting with the absorption axis 51a of the observation side polarizing plate 51 at an angle of substantially 45°, for example, the homogeneous alignment direction of the liquid crystal molecules 12. The second λ/4 plate 55 is disposed so that its slow axis 55a is directed substantially perpendicularly to the slow axis 54a of the first λ/4 plate 54. The third λ/4 plate 56 is disposed so that its slow axis 56a is directed substantially perpendicularly to the slow axis 55a of the second λ/4 plate 55. The fourth λ/4 plate 57 is disposed so that its slow axis 57a is directed substantially perpendicularly to the slow axis 54a of the first λ/4 plate 54. In addition, each of the first, second and third λ/4 plates 54, 55, 56 has an area greater than that of the region 10a enclosed by the seal material 10.

Furthermore, the first λ/4 plate 54, the first observation side polarizing plate 51 and the second λ/4 plate 55 are stacked on each other and arranged in a closely contacted state on the outer surface of an observation side substrate 2 of the liquid crystal element 1. The second observation side polarizing plate 52 and the third λ/4 plate 56 are stacked on each other and arranged in a closely contacted state on the surface of the protective plate 25 that faces the liquid crystal element 1. Moreover, the second λ/4 plate 55 and the third λ/4 plate 56 are arranged to leave a predetermined space in between.

In addition, the fourth λ/4 plate 57 is disposed to be in close contact with the outer surface of a rear side substrate 3 of the liquid crystal element 1 or in proximity to the outer surface of the rear side substrate 3. The rear side polarizing plate 53 is stacked on or disposed in proximity to the fourth λ/4 plate 57.

Here, the third λ/4 plate 56 is preferably disposed as an optical film proximate to the second λ/4 plate 55 between the second λ/4 plate 55 and the protective plate 25.

The display apparatus according to this embodiment has a display system that is configured by the liquid crystal element 1, by the first λ/4 plate 54 and the first observation side polarizing plate 51, and by the fourth λ/4 plate 57 and the rear side polarizing plate 53. Using this display system, the display apparatus according to this embodiment performs the reflection display and the transmission display in the same manner as the display apparatus in the first embodiment described above.

The linearly polarized light that has exited from the observation side polarizing plate 51 of the display system to the observation side penetrates the second λ/4 plate 55 and the third λ/4 plate 56 having their slow axes that intersect perpendicularly to each other. Thus, this linearly polarized light remains as the linearly polarized light perpendicular to the absorption axis 52a of the second observation side polarizing plate 52 and enters the second observation side polarizing plate 52 without changing the polarization state, and then penetrates the second observation side polarizing plate 52 and thus exits to the observation side of the liquid crystal element 30a.

Furthermore, in this display apparatus, the first λ/4 plate 54, the first observation side polarizing plate 51 and the second λ/4 plate 55 are stacked on one other and arranged in a closely contacted state on the outer surface of an observation side substrate 2 of the liquid crystal element 1. The second observation side polarizing plate 52 and the third λ/4 plate 56 are stacked on each other and arranged in a closely contacted state on the surface of the protective plate 25 that faces the liquid crystal element 1. Moreover, the second λ/4 plate 55 and the third λ/4 plate 56 are arranged to leave a predetermined space in between. Consequently, the reflection of the light entering from the observation side can be sufficiently reduced, and display with high contrast can be performed.

That is, in this display apparatus, part of the light that has entered from the observation side is reflected by interfaces having great refractive index differences, that is, by the surface of the protective plate 25, by the inner surface of the third λ/4 plate 56 that faces the second λ/4 plate 55 and by the surface of the second λ/4 plate 55 that faces the third λ/4 plate 56 in the process of entering the liquid crystal element 1 after penetrating the protective plate 25, the second observation side polarizing plate 52 and the third λ/4 plate 56 stacked in a closely contacted state on the surface of the protective plate 25 that faces the liquid crystal element 1 and further penetrating the second λ/4 plate 55, the first observation side polarizing plate 51 and the first λ/4 plate 54 stacked in a closely contacted state on the outer surface of the observation side substrate 2 of the liquid crystal element 1.

Among the lights reflected by the above-mentioned interfaces having the great refractive index differences, both the light reflected by the inner surface of the third λ/4 plate 56 that faces the second λ/4 plate 55 and the light reflected by the surface of the second λ/4 plate 55 that faces the third λ/4 plate 56 are reflected light that has entered from the observation side, penetrated the second observation side polarizing plate 52 to become linearly polarized light perpendicular to the absorption axis 52a of the second observation side polarizing plate 52, and been provided with a λ/4 phase difference by the third λ/4 plate 56 to become circularly polarized light. These reflected lights (circularly polarized lights) again penetrate the third λ/4 plate 56 and are thus provided with a λ/4 phase difference. The reflected lights become linearly polarized lights having a λ/2 phase difference and parallel to the absorption axis 52a of the second observation side polarizing plate 52, and are absorbed by the second observation side polarizing plate 52.

As a result, the reflected light that has entered from the observation side and has been reflected, on a path to enter the liquid crystal element 1, by the inner surface of the third λ/4 plate 56 that faces the second λ/4 plate 55 and by the surface of the second λ/4 plate 55 that faces the third λ/4 plate 56 is absorbed by the second observation side polarizing plate 52 and does not exit to the observation side. Thus, surface reflection can be sufficiently reduced, and display with high contrast can be performed.

In addition, the display apparatus according to this embodiment is a reflection/transmission type for performing the reflection display and the transmission display. However, these embodiments are not limited to the reflection/transmission type display apparatus, and are also applicable to both a reflection type display apparatus for only performing the reflection display using an external light and a transmission type display apparatus for only performing the transmission display using the illumination light from the surface light source 19. In the case of this reflection type display apparatus, the rear side polarizing plate 53, the fourth λ/4 plate 57 and the surface light source 19 in the embodiments described above are not necessary.

Moreover, the display apparatus described above has the nontwist homogeneous alignment type liquid crystal element 1. However, the arrangement of the first and second observation side polarizing plates 51, 52, the opposite polarizing plate 53, the first to third λ/4 plates 54, 55, 56 and the fourth λ/4 plate 57 in this embodiment can be applied to display apparatuses having other types of liquid crystal elements. For example, the liquid crystal element can be any one of a vertical alignment type, a TN type, an STN type in which liquid crystal molecules are in twist alignment at a twisted angle of 180° to 270° between a pair of substrates, a lateral-field control type, and a bend alignment type in which liquid crystal molecules are in bend alignment. Alternatively, the liquid crystal element can be a ferroelectric or antiferroelectric liquid crystal element.

### Sixth Embodiment

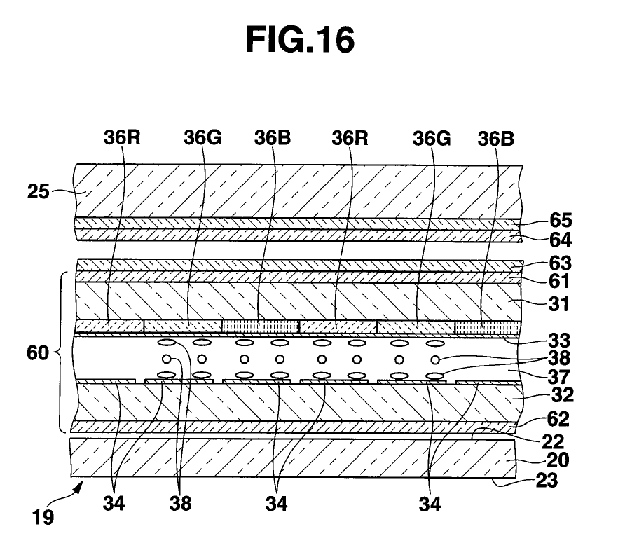

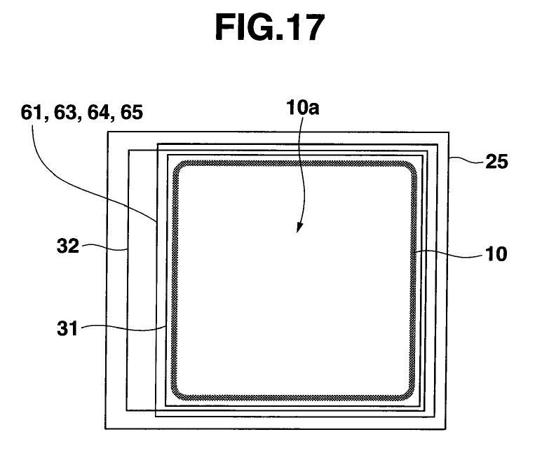

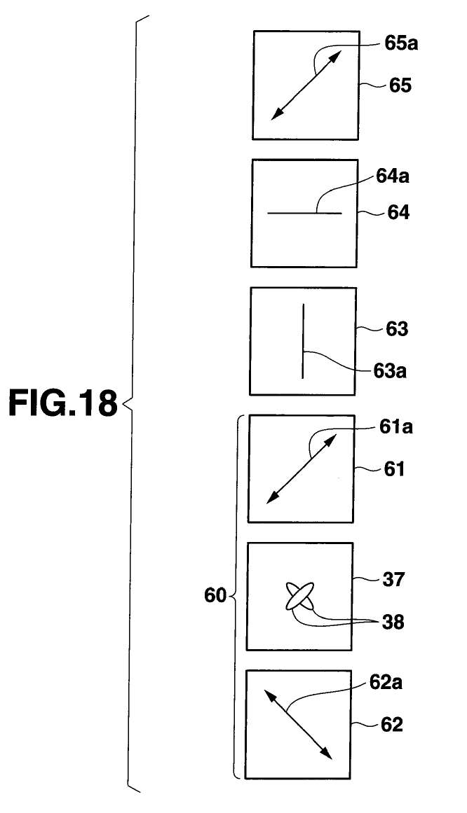

FIG. 16, FIG. 17 and FIG. 18 show a sixth embodiment of the invention. FIG. 16 is a partially enlarged sectional view of a display apparatus. FIG. 17 is a schematic plan view of the display apparatus. It is to be noted that a surface light source 19 and a protective plate 25 in this embodiment are the same as the surface light source 19 and the protective plate 25 in the first embodiment.

As shown in FIG. 16, the display apparatus according to this embodiment comprises: a liquid crystal display device 60 having a liquid crystal layer 37 that is sealed in a space between a pair of observation side and opposite transparent substrates 31, 32 arranged face to face and in which liquid crystal molecules 38 are in a predetermined alignment state, having electrodes 33, 34 provided on at least one (both in this embodiment) of the inner surfaces of the pair of substrates 31, 32 that face each other to form a plurality of pixels for changing the alignment state of the liquid crystal molecules 38 in response to the application of a voltage to control the transmission of a light and having a pair of observation side and opposite polarizing plates 61, 62 arranged across the pair of substrates 31, 32; a first λ/4 plate (quarter-wavelength retardation plate) 63 that has a slow axis 63a (see FIG. 18) in a direction intersecting with an absorption axis 61a (see FIG. 18) of an observation side polarizing plate 61 of the liquid crystal display device 60 at an angle of substantially 45° and that is disposed closer to the observation side than the liquid crystal display device 60; a second λ/4 plate 64 that has a slow axis 64a (see FIG. 18) in a direction substantially perpendicular to the slow axis 63a of the first λ/4 plate 63 and that is disposed closer to the observation side than the first λ/4 plate 63; a second observation side polarizing plate 65 that has an absorption axis 65a (see FIG. 18) in a direction substantially parallel to the absorption axis 61a of the observation side polarizing plate 61 of the liquid crystal display device 60 and that is disposed closer to the observation side than the second λ/4 plate 64; a surface light source 19 that is disposed on the rear side of the liquid crystal display device 60; and a protective plate 25 disposed closer to the observation side than the second observation side polarizing plate 65.

In this embodiment, the liquid crystal display device 60 is a TN type element in which the liquid crystal molecules 38 of the liquid crystal layer 37 are in twist alignment at a twisted angle of substantially 90° between the pair of substrates 31, 32. The pair of substrates 31, 32, the electrodes 33, 34 provided on the inner surfaces of the substrates 31, 32, and the liquid crystal layer 37 are the same in configuration as the equivalents in the liquid crystal element 30 in the third embodiment.

FIG. 18 shows the alignment state of the liquid crystal molecules 38 of the liquid crystal element 30 forming the liquid crystal display device 60, the directions of the absorption axes 61a, 62a of the pair of polarizing plates 61, 62, the directions of the slow axes 63a, 64a of the first and second λ/4 plates 63, 64, and the direction of the absorption axis 65a of the second observation side polarizing plate 65.

As shown in FIG. 18, the liquid crystal molecules 38 of the liquid crystal layer 37 of the liquid crystal element 30 are in twist alignment at a twisted angle of substantially 90° between the pair of substrates 31, 32. The observation side polarizing plate 61 is disposed so that its absorption axis 61a is directed substantially in parallel or perpendicularly to the alignment direction of the liquid crystal molecules 38 in the vicinity of the observation side substrate 31 to which the observation side polarizing plate 41 of the liquid crystal element 30 is adjacent. The rear side polarizing plate 62 is disposed so that its absorption axis 62a is directed substantially in parallel or perpendicularly to the alignment direction of the liquid crystal molecules 38 in the vicinity of the rear side substrate 32 to which the rear side polarizing plate 62 of the liquid crystal element 30 is adjacent. In addition, in this embodiment, the absorption axis 61a of the observation side polarizing plate 61 is substantially parallel to the alignment direction of the liquid crystal molecules 38 in the vicinity of the observation side substrate 31, and the absorption axis 62a of the rear side polarizing plate 62 is substantially perpendicular to the absorption axis 61a of the observation side polarizing plate 61. Moreover, each of the observation side polarizing plate 61, the rear side polarizing plate 62 and the second observation side polarizing plate 65 has an area greater than that of a region 10a enclosed by a seal material 10, that is, has an area greater than that of a display area for displaying images.

Furthermore, of the first and second λ/4 plates 63, 64, the first λ/4 plate 63 on the side of the liquid crystal display device 60 is disposed so that its slow axis 63a is directed substantially in parallel to one of two directions intersecting with the absorption axis 61a of the observation side polarizing plate 61 of the liquid crystal display device 60 at an angle of substantially 45°, for example, the alignment direction of the liquid crystal molecules 38 in the vicinity of the observation side substrate 31 of the liquid crystal element 30. The second λ/4 plate 64 is disposed so that its slow axis 64a is directed substantially perpendicularly to the slow axis 63a of the first λ/4 plate 63. Moreover, the second observation side polarizing plate 65 is disposed so that its absorption axis 65a is substantially parallel to the absorption axis 61a of the observation side polarizing plate 61 of the liquid crystal display device 60. In addition, each of the first and second λ/4 plates 63, 64 has an area greater than that of the region 10a enclosed by the seal material 10.

Furthermore, the observation side polarizing plate 61 of the liquid crystal display device 60 and the first λ/4 plate 63 are stacked on each other and arranged in a closely contacted state on the outer surface of the observation side substrate 31 of the liquid crystal display device 60. The second observation side polarizing plate 65 and the second λ/4 plate 64 are stacked on each other and arranged in a closely contacted state on the surface of the protective plate 25 that faces the liquid crystal display device 60. Moreover, the first λ/4 plate 63 and the second λ/4 plate 64 are arranged to leave a predetermined space in between. In addition, the rear side polarizing plate 62 of the liquid crystal display device 60 is disposed to be in close contact with the outer surface of the rear side substrate 32 of the liquid crystal display device 60 or in proximity to the outer surface of the rear side substrate 32.

Here, the second λ/4 plate 64 is preferably disposed as an optical film proximate to the first λ/4 plate 63 between the first λ/4 plate 63 and the protective plate 25.

The display apparatus according to this embodiment causes the light that has exited from the liquid crystal display device 60 to the observation side (the light corresponding to an image to be displayed) to penetrate the rear side polarizing plate 53, the second λ/4 plate 64 and the second observation side polarizing plate 65 and then exit to the observation side.

The light exiting from the liquid crystal display device 60 to the observation side is a linearly polarized light perpendicular to the absorption axis 61a of the observation side polarizing plate 61 of the liquid crystal display device 60. This linearly polarized light penetrates the first λ/4 plate 63 and the second λ/4 plate 64 having their slow axes that intersect perpendicularly to each other. Thus, this linearly polarized light remains as the linearly polarized light perpendicular to the absorption axis 65a of the second observation side polarizing plate 65 and enters the second observation side polarizing plate 65 without changing the polarization state, and then penetrates the second observation side polarizing plate 65 and thus exits to the observation side.

Furthermore, in this display apparatus, the observation side polarizing plate 61 of the liquid crystal display device 60 and the first λ/4 plate 63 are stacked on each other and arranged in a closely contacted state on the outer surface of the observation side substrate 31 of the liquid crystal element 30. The second observation side polarizing plate 65 and the second λ/4 plate 64 are stacked on each other and arranged in a closely contacted state on the surface of the protective plate 25 that faces the liquid crystal display device 60. Moreover, the first λ/4 plate 63 and the second λ/4 plate 64 are arranged to leave a predetermined space in between. Thus, the light that has entered from the observation side and has been reflected by the inner surface of the second λ/4 plate 64 that faces the first λ/4 plate 63 and the light that has reflected by the surface of the first λ/4 plate 63 that faces the second λ/4 plate 64 enter the second observation side polarizing plate 65 in the form of linearly polarized lights parallel to the absorption axis 65a of the second observation side polarizing plate 65. These lights can be absorbed by the second observation side polarizing plate 65.

As a result, the reflected light that has entered from the observation side and has been reflected, on a path to enter the liquid crystal display device 60, by the inner surface of the second λ/4 plate 64 that faces the first λ/4 plate 63 and by the surface of the first λ/4 plate 63 that faces the second λ/4 plate 64 is absorbed by the second observation side polarizing plate 65 and does not exit to the observation side. Thus, surface reflection can be sufficiently reduced, and display with high contrast can be performed.

Moreover, the display apparatus according to this embodiment has the TN type liquid crystal element 30 as the liquid crystal element forming the liquid crystal display device 60. However, the liquid crystal display device is not limited to the TN type, and may be any one of an STN type, a nontwist homogeneous alignment type, a vertical alignment type, the TN type, a lateral-field control type and a bend alignment type. Alternatively, the liquid crystal display device may be a ferroelectric or antiferroelectric liquid crystal element.

### Seventh Embodiment

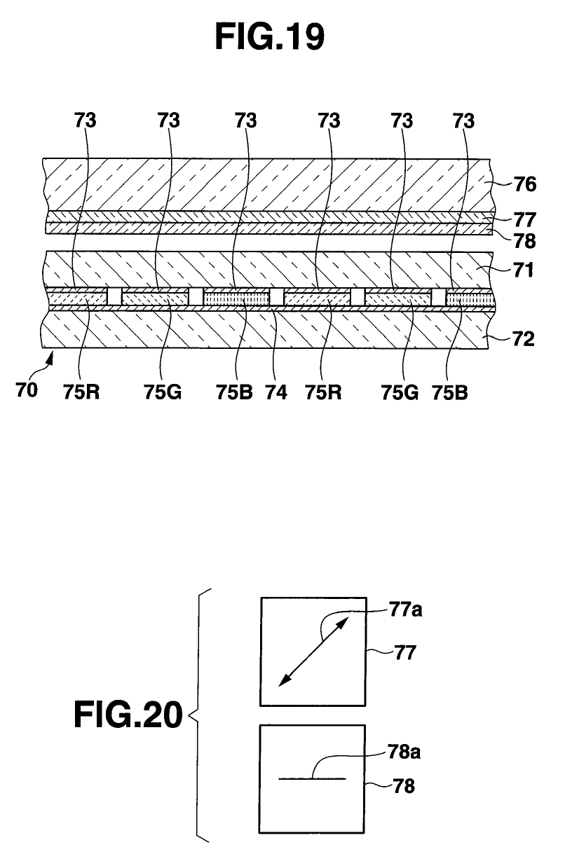

FIG. 19 and FIG. 20 show a seventh embodiment of the invention. FIG. 19 is a partially enlarged sectional view of a display apparatus.

As shown in FIG. 19, the display apparatus according to this embodiment comprises: a light-emitting type display device 70; a transparent protective plate 76 that is made of, for example, hardened glass and that disposed on the observation side of the display device 70; a polarizing plate 77 that has an absorption axis 77a (see FIG. 20) in a predetermined direction and that is disposed between the display device 70 and the protective plate 76; a λ/4 plate (quarter-wavelength retardation plate) 78 that has a slow axis 78a (see FIG. 20) in a direction intersecting with the absorption axis 77a of the polarizing plate 77 at an angle of substantially 45° and that is disposed between the display device 70 and the polarizing plate 77.

The light-emitting type display device 70 is, for example, an organic electroluminescence (EL) display device. This display device comprises: a transparent observation side substrate 71 and a rear side substrate 72 that is disposed face to face with the substrate 71 and that is on the side opposite to the observation side; a plurality of transparent pixel electrodes 73 formed to be arranged in a row direction and a column direction on the inner surface of the observation side substrate 71 that faces the rear side substrate 72; an opposed electrode 74 formed on the inner surface of the rear side substrate 72 that faces the observation side substrate 71; and red, green and blue three organic EL light-emitting member layers 75R, 75G, 75B formed to intervene between the electrodes 73, 74 for each of a plurality of pixels constituted of regions where the plurality of pixel electrodes 73 and the opposed electrode 74 face each other.

In addition, the organic EL display device 70 is an active matrix display device using a TFT as an active element. Although not shown in FIG. 19, a plurality of TFTs, a plurality of scanning lines and a plurality of signal lines are provided on the inner surface of the observation side substrate 71. The plurality of TFTs are connected to the plurality of pixel electrodes 73, respectively. The plurality of scanning lines supply gate signals to the TFTs in the respective rows. The plurality of signal lines supply data signals to the TFTs in the respective columns.

FIG. 20 shows the direction of the absorption axis 77a of the polarizing plate 77 and the direction of the slow axis 78a of the λ/4 plate 78 in the display apparatus according to this embodiment. The polarizing plate 77 is disposed so that its absorption axis 77a is directed to intersect with, for example, the vertical direction of the screen of the display apparatus at an angle of substantially 45° in one direction. The λ/4 plate 78 is disposed so that its slow axis 78a is directed to intersect with the absorption axis 77a of the polarizing plate 77 at an angle of substantially 45°, for example, substantially perpendicularly to the vertical direction of the screen.

Furthermore, the polarizing plate 77 and the λ/4 plate 78 are stacked on each other and arranged in a closely contacted state on the surface of the protective plate 76 that faces the display device 70. The display device 70 and the λ/4 plate 78 are arranged to leave a space in between.

This display apparatus causes the light that has exited from the organic EL display device 70 to the observation side (the light corresponding to an image to be displayed) to penetrate the λ/4 plate 78 and the polarizing plate 77 and then exit to the observation side. The light (unpolarized light) that has exited from the display device 70 to the observation side penetrates the λ/4 plate 78 and enters the polarizing plate 77. Out of this light, a linearly polarized light component perpendicular to the absorption axis 77a of the polarizing plate 77 penetrates the polarizing plate 77, and then exits to the observation side.

Furthermore, in this display apparatus, the polarizing plate 77 and the λ/4 plate 78 are stacked on each other and arranged in a closely contacted state on the surface of the protective plate 76 that faces the display device 70, and the display device 70 and the λ/4 plate 78 are arranged to leave a space in between. As a result, the light that has entered from the observation side and has been reflected by the surface of the λ/4 plate 78 that faces the display device 70 and the light reflected by the outer surface of the observation side substrate 71 of the display device 70 enter the polarizing plate 77 in the form of linearly polarized lights parallel to the absorption axis 77a of the polarizing plate 77. These lights can be absorbed by the polarizing plate 77.

As a result, the reflected light that has entered from the observation side and has been reflected, on a path to enter the display device 70, by the surface of the λ/4 plate 78 that faces the display device 70 and by the outer surface of the observation side substrate 71 of the display device 70 is absorbed by the observation side substrate 71 and does not exit to the observation side. Thus, surface reflection can be sufficiently reduced, and display with high contrast can be performed.

In addition, the display apparatus according to this embodiment has the organic EL display device 70 as the light-emitting type display device. However, the light-emitting type display device may be a different light-emitting type display device such as a plasma display device.

### Other Embodiments

In the display apparatus according to each of the embodiments described above, the protective plate 25, 76 is preferably an antiglare protective plate whose surface has been treated to prevent the reflection of the external light. The use of this antiglare protective plate makes it possible to further reduce the reflection of the light that has entered from the observation side and perform display with higher contrast.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A display apparatus comprising:
a liquid crystal element having a liquid crystal layer sealed in a space between a first substrate and a second substrate that are arranged face to face with each other, liquid crystal molecules being aligned in a predetermined alignment state in the liquid crystal layer, the liquid crystal element being provided with a plurality of pixels that change the alignment state of the liquid crystal molecules in response to the application of a voltage to the liquid crystal layer to control the transmission of a light;
a protective plate that is greater in area than the first substrate and that is disposed so that the first substrate intervenes between the protective plate and the second substrate;
a first polarizing plate that has an absorption axis in a predetermined direction and that is disposed between the protective plate and the first substrate to be in close contact with the protective plate; and
a first quarter-wavelength retardation plate that has a slow axis in a direction intersecting with the absorption axis of the first polarizing plate at an angle of 45° and that is disposed between the first substrate and the first polarizing plate to be in close contact with the first polarizing plate.

2. The display apparatus according to claim 1, wherein the first quarter-wavelength retardation plate is disposed so that a predetermined space is left between the first quarter-wavelength retardation plate and the first substrate.

3. The display apparatus according to claim 2, wherein the first quarter-wavelength retardation plate is disposed as an optical film proximate to the first substrate between the first substrate and the protective plate.

4. The display apparatus according to claim 3, further comprising: a second polarizing plate that has an absorption axis in a direction perpendicular or parallel to the absorption axis of the first polarizing plate and that is disposed so that the liquid crystal element intervenes between the second polarizing plate and the first substrate; and a second quarter-wavelength retardation plate that has a slow axis in a direction perpendicular to the slow axis of the first quarter-wavelength retardation plate and that is disposed between the liquid crystal element and the second polarizing plate.

5. The display apparatus according to claim 4, wherein the liquid crystal element is adapted so that the liquid crystal molecules of the liquid crystal layer are in homogeneous alignment when no voltage is applied to the liquid crystal layer, and the first polarizing plate and the second polarizing plate are arranged so that the absorption axes thereof intersect with the direction of the homogeneous alignment of the liquid crystal molecules at an angle of 45°.

6. The display apparatus according to claim 4, wherein the liquid crystal element is adapted so that the liquid crystal molecules of the liquid crystal layer are aligned perpendicularly to the surfaces of the substrates when no voltage is applied to the liquid crystal layer and so that the liquid crystal molecules of the liquid crystal layer fall down in a predetermined direction when a voltage is applied to the liquid crystal layer, and the first polarizing plate and the second polarizing plate are arranged so that the absorption axes thereof intersect at an angle of 45° with the direction in which the liquid crystal molecules fall down when a voltage is applied to the liquid crystal layer.

7. The display apparatus according to claim 3, wherein the liquid crystal element comprises a reflection/transmission type element in which a reflection display area and a transmission display area are provided in each pixel.

8. The display apparatus according to claim 3, wherein the second substrate is greater in area than the first substrate.

9. The display apparatus according to claim 3, wherein the first substrate and the second substrate are bonded together by a seal material formed into a frame shape, and the first polarizing plate and the first quarter-wavelength retardation plate are greater in area than a region enclosed by the seal material.

10. A display apparatus comprising:
a liquid crystal element having a liquid crystal layer sealed in a space between a first substrate and a second substrate that are arranged face to face with each other, liquid crystal molecules being aligned in a predetermined alignment state in the liquid crystal layer, the liquid crystal element being provided with a plurality of pixels that change the alignment state of the liquid crystal molecules in response to the application of a voltage to the liquid crystal layer to control the transmission of a light;
a protective plate that is greater in area than the first substrate and that is disposed so that the first substrate intervenes between the protective plate and the second substrate;
a first polarizing plate that has an absorption axis in a predetermined direction and that is disposed between the protective plate and the first substrate to be in close contact with the protective plate;
a first quarter-wavelength retardation plate that has a slow axis in a direction intersecting with the absorption axis of the first polarizing plate at an angle of 45° and that is disposed between the first substrate and the first polarizing plate to be in close contact with the first substrate; and
a second quarter-wavelength retardation plate that has a slow axis in a direction perpendicular to the slow axis of the first quarter-wavelength retardation plate and that is disposed between the first polarizing plate and the first quarter-wavelength retardation plate to be in close contact with the first polarizing plate.

11. The display apparatus according to claim 10, wherein the first quarter-wavelength retardation plate is disposed so that a predetermined space is left between the first quarter-wavelength retardation plate and the second quarter-wavelength retardation plate.

12. The display apparatus according to claim 11, wherein the second quarter-wavelength retardation plate is disposed as an optical film proximate to the first quarter-wavelength retardation plate between the first quarter-wavelength retardation plate and the protective plate.

13. The display apparatus according to claim 12, further comprising: a second polarizing plate that has an absorption axis in a direction perpendicular or parallel to the absorption axis of the first polarizing plate and that is disposed so that the liquid crystal element intervenes between the second polarizing plate and the first substrate.

14. The display apparatus according to claim 13, wherein the liquid crystal element is adapted so that the liquid crystal molecules of the liquid crystal layer are in twist alignment at a twisted angle of 90° when no voltage is applied to the liquid crystal layer, and the first polarizing plate and the second polarizing plate are arranged so that the absorption axes thereof are parallel or perpendicular to the alignment direction of the liquid crystal molecules at interfaces with the substrates.

15. The display apparatus according to claim 13, wherein the liquid crystal element is adapted so that the liquid crystal molecules of the liquid crystal layer are in homogeneous alignment when no voltage is applied to the liquid crystal layer, and the first polarizing plate and the second polarizing plate are arranged so that the absorption axes thereof intersect at an angle of 45° with the direction of the homogeneous alignment of the liquid crystal molecules.

16. A display apparatus comprising:
a liquid crystal element having a liquid crystal layer sealed in a space between a first substrate and a second substrate that are arranged face to face with each other, liquid crystal molecules being aligned in a predetermined alignment state in the liquid crystal layer, the liquid crystal element being provided with a plurality of pixels that change the alignment state of the liquid crystal molecules in response to the application of a voltage to the liquid crystal layer to control the transmission of a light;
a protective plate that is greater in area than the first substrate and that is disposed so that the first substrate intervenes between the protective plate and the second substrate;
a first polarizing plate that has an absorption axis in a predetermined direction and that is disposed between the protective plate and the first substrate to be in close contact with the protective plate;
a first quarter-wavelength retardation plate that has a slow axis in a direction intersecting with the absorption axis of the first polarizing plate at an angle of 45° and that is disposed between the first substrate and the first polarizing plate to be in close contact with the first substrate;
a second quarter-wavelength retardation plate that has a slow axis in a direction perpendicular to the slow axis of the first quarter-wavelength retardation plate and that is disposed between the first polarizing plate and the first quarter-wavelength retardation plate to be in close contact with the first polarizing plate;
a second polarizing plate that has an absorption axis in a direction parallel to the absorption axis of the first polarizing plate and that is disposed between the first quarter-wavelength retardation plate and the second quarter-wavelength retardation plate to be in close contact with the first quarter-wavelength retardation plate; and
a third quarter-wavelength retardation plate that has a slow axis in a direction intersecting with the absorption axis of the second polarizing plate at an angle of 45° and that is disposed between the second polarizing plate and the second quarter-wavelength retardation plate to be in close contact with the second polarizing plate.

17. The display apparatus according to claim 16, wherein the third quarter-wavelength retardation plate is disposed so that a predetermined space is left between the third quarter-wavelength retardation plate and the second quarter-wavelength retardation plate.

18. The display apparatus according to claim 17, wherein the second quarter-wavelength retardation plate is disposed as an optical film proximate to the third quarter-wavelength retardation plate between the third quarter-wavelength retardation plate and the protective plate.

19. A display apparatus comprising:
a liquid crystal element having a liquid crystal layer sealed in a space between a first substrate and a second substrate that are arranged face to face with each other, liquid crystal molecules being aligned in a predetermined alignment state in the liquid crystal layer, the liquid crystal element being provided with a plurality of pixels that change the alignment state of the liquid crystal molecules in response to the application of a voltage to the liquid crystal layer to control the transmission of a light;
a protective plate that is greater in area than the first substrate and that is disposed so that the first substrate intervenes between the protective plate and the second substrate;
a first polarizing plate that has an absorption axis in a predetermined direction and that is disposed between the protective plate and the first substrate to be in close contact with the protective plate;
a second polarizing plate that has an absorption axis in a direction parallel to the absorption axis of the first polarizing plate and that is disposed between the first substrate and the first polarizing plate to be in close contact with the first substrate;
a first quarter-wavelength retardation plate that has a slow axis in a direction intersecting with the absorption axis of the first polarizing plate at an angle of 45° and that is disposed between the first polarizing plate and the second polarizing plate to be in close contact with the first polarizing plate; and
a second quarter-wavelength retardation plate that has a slow axis in a direction perpendicular to the slow axis of the first quarter-wavelength retardation plate and that is disposed between the first quarter-wavelength retardation plate and the second polarizing plate to be in close contact with the second polarizing plate.

20. The display apparatus according to claim 19, wherein the first quarter-wavelength retardation plate is disposed so that a predetermined space is left between the first quarter-wavelength retardation plate and the second quarter-wavelength retardation plate.

21. The display apparatus according to claim 20, wherein the first quarter-wavelength retardation plate is disposed as an optical film proximate to the second quarter-wavelength retardation plate between the second quarter-wavelength retardation plate and the protective plate.

22. A display apparatus comprising:
a light-emitting type display device;
a protective plate;
a polarizing plate that has an absorption axis in a predetermined direction and that is disposed between the light-emitting type display device and the protective plate to be in close contact with the protective plate; and
a quarter-wavelength retardation plate that has a slow axis in a direction intersecting with the absorption axis of the polarizing plate at an angle of 45° and that is disposed between the light-emitting type display device and the polarizing plate to be in close contact with the polarizing plate.
